(19) United States
(12) Patent Application Publication
(10) Pub. No.: US 2026/0225340 A1
(43) Pub. Date: Aug. 6, 2026

(54) CONVEYOR BELT

(71) Applicant: Sprick GmbH Bielefelder Papier- und Wellpappenwerke & Co., Muenchen (DE)

(72) Inventors: Bastian Schalk, Detmold (DE); Erik Albert, Horn-Bad Meinberg (DE); Vitali Krebs, Ahlen (DE); Marco Schwarberg, Melle (DE)

(73) Assignee: Sprick GmbH Bielefelder Papier- und Wellpappenwerke & Co., Muenchen (DE)

(21) Appl. No.: 18/695,979

(22) PCT Filed: Sep. 28, 2022
(86) PCT No.: PCT/EP2022/077004

§ 371 Date: Apr. 29, 2026

(30) Foreign Application Priority Data
Sep. 28, 2021 (DE) 10 2021 125 083.8
Sep. 28, 2021 (DE) 10 2021 125 090.0
Sep. 28, 2021 (DE) 10 2021 125 147.8

(51) Int. Cl. B31D 5/00; B65H 35/00

(52) U.S. Cl. CPC B31D 5/0056; B65H 35/0006; B31D 2205/0058; B65H 2404/2615; B65H 2601/261; B65H 2701/1944; B65H 2801/63

(57) ABSTRACT

Techniques for producing a three-dimensional packaging product from a web-shaped raw material, may use an apparatus having a preforming station which deforms the raw material web into a three-dimensional intermediate product having at least one crumple cavity extending in the web direction, a separating station which adjoins the preforming station in the conveying direction of the raw material and separates a packaging product of a desired length from the raw material web, and an output device adjoining the separating station in the conveying direction of the raw material and having a pair of mutually opposite continuous conveyors for discharging the separated packaging product. A continuous conveyor may be mounted movably relative to another continuous conveyor in order to allow access between the continuous conveyors.

### CROSS REFERENCE TO RELATED APPLICATIONS

This patent application is a U.S. National Stage Application of International Application No. PCT/EP2022/077004, filed Sep. 28, 2022, which claims priority to German Patent Application No. 10 2021 125 083.8, filed Sep. 28, 2021, German Patent Application No. 10 2021 125 090.0, filed Sep. 28, 2021, and German Patent Application No. 10 2021 125 147.8, filed Sep. 28, 2021. Each of these applications is incorporated herein by reference in its entirety.

### BACKGROUND

### Field

The present disclosure relates to an apparatus for mechanically producing a three-dimensional packaging product from a web-shaped raw material, in particular from paper. Furthermore, the present disclosure relates to a packaging product manufactured in particular by means of a packaging product manufacturing apparatus according to the disclosure and to a system comprising an apparatus for producing a three-dimensional packaging product from a web-shaped raw material and a raw material supply.

### Related Art

Generic packaging products are flexible and shock-absorbing and are used to be filled into transport boxes or cartons in order to protect transport items. A packaging product can therefore also be described as a shock-absorbing filling material product. A three-dimensional packaging product is created by deforming a two-dimensional paper web raw material in a predetermined manner in order to produce the three-dimensional packaging product in an indefinitely repeatable manner.

Recovered paper is increasingly being used for the paper material, mainly for ecological reasons, but due to its inhomogeneity it is difficult to deform, especially if the three-dimensional packaging product is to be manufactured uniformly and as easily and economically as possible. The packaging material web can be made from paper, such as recycled paper, in particular recovered paper and/or 100% recyclable paper, which can be produced without chemical ingredients. Recycled paper is in particular paper materials with a low proportion (less than 50%) of paper material containing fresh fibers. For example, paper materials containing 70% to 100% recovered paper are used. The recycled paper for the purposes of the present disclosure can be paper material which can have a tensile strength index along the machine direction of at most 90 Nm/g, preferably a tensile strength of 15 Nm/g to 60 Nm/g, and a tensile strength index transversely to the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or the tensile strength index. Additionally, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the burst index. Furthermore, the packaging material has a mass per unit area of in particular 40 g/m2 to max. 140 g/m2. The initial packaging material can be in the form of a roll of web material or a zig-zag folded stack of packaging material, also known as a leporello-stack.

An example of a generic packaging product is given in EP 2 711 167 B1. In a first forming step, according to EP 2 711 167 B1, the longitudinal edge strips of the paper web are rolled essentially loosely inwards. In a central connecting section or middle area, which connects the two rolled-up longitudinal edge strips of the paper web section and which each realize a crumple cavity, an embossing is introduced to stiffen and fix the longitudinal edge strips of the packaging product, which is formed by a sequence of valleys and raised sections. In this way, the laterally rolled-up cushion section, which delimits a cavity to form a crumple zone, should be significantly thicker than the embossed center section. Perforations can also be introduced in the embossed deformation or fastening zone in the center area, which causes the superimposed paper web layers to interlock.

A packaging product manufacturing apparatus of the same type is known, for example, from US2021/0023808 A1. The packaging product manufacturing apparatus comprises the following components as viewed in the conveying direction of the web-shaped raw material: a preforming station for forming lateral crumple cavities; an embossing station for embossing the center area of the preformed paper web; a separating station for separating packaging products of a certain length from the preformed paper web; an output device via which the separated packaging products are dispensed from the packaging product manufacturing apparatus. The output device comprises a pair of opposing conveyor belts which are motor-driven by a common motor to actively convey the packaging products towards a removal opening of the machine from which the packaging products can be removed. The conveyor belts are arranged symmetrically with respect to a center axis lying between them and are inclined in such a way that the conveying path delimiting them decreases continuously from an end on the separating station side towards the removal opening.

The separating station in US 2021/0023808 A1 also comprises a guillotine-type cutter which is borne in such a way that it performs a cutting movement in the vertical direction in the gravitational direction during a cutting operation.

Several disadvantages have been identified in the design and arrangement of the two conveyor belts in relation to each other in accordance with US 2021/002808 A1 with regard to the formation and removal of a paper jam. In particular, when short packaging products are to be produced, it has been found that due to the large vertical distance between the end of the lower conveyor belt on the separation station side and the position at which the packaging product is separated from the pre-formed paper web, the packaging products tend not to be caught and dragged along reliably enough by the lower conveyor belt. Furthermore, the short packaging products, which more or less fall off after separation, can become jammed and wedged inside the packaging machine, which can lead to a paper jam. It can also happen that, due to the symmetrical arrangement of the upper and lower conveyor belts, some packaging products, particularly smaller ones, which have risen vertically after falling from the separating station, unintentionally leave the conveying path at the top between the upper conveyor belt and the separating station. Furthermore, US 2021/0023808 A1 only provides for a complex way of clearing an existing paper jam. Access to the inside of the machine is not easily possible without risk of injury to the operator.

This tendency to form a paper jam in US 2021/0023808 A1 is also increased because the cutting movement is embodied in the gravitational direction, so that the trailing end of the packaging product to be cut off is pressed vertically downwards by the cutter, so that the leading end of the packaging product can rise up due to the leverage effect. In addition, there are further disadvantages with regard to the combination with the guillotine cut in the gravitational direction. Furthermore, there is potential for improvement with regard to the reliable separation of the packaging products.

Another generic packaging product manufacturing apparatus is known, for example, from WO 95/31296 A1. The packaging product manufacturing apparatus comprises a forming station at which the web-shaped raw material is deformed into a three-dimensional packaging product. Three pairs of drive wheels are integrated in the forming station, which are responsible for feeding and conveying the raw material. Downstream of the forming station is an embossing station with two embossing gears, by means of which a central section of the preformed packaging product is deformed and embossed. The apparatus also includes a motor that drives both the embossing gears and the drive wheels. The drive force is first transmitted to the embossing gears and then to the drive wheels via a belt drive.

A significant disadvantage of the drive kinematics of WO 95/31296 A1 is that the force is deflected over very long distances and frequently. Several gears are required to transmit the force to the various pick-ups.

The inventors of the present disclosure have also recognized that there is a need for small paper packaging products, i.e. with a reduced width transversely to the longitudinal extension, because these can be more easily integrated into narrow volumes to be padded in packaging cartons or bags. In the past, packaging products of the generic shape with an undulating embossed section extending in the longitudinal direction and symmetrically adjoining tubular crumple cavities at the sides, which were produced by forming a web-shaped raw material in one piece, were always manufactured to a fairly uniform size, wherein the constraints of the paper material and the packaging product manufacturing apparatus intended for production did not permit a width of less than 15 cm. The inventors of the present disclosure have now succeeded in creating packaging product manufacturing apparatus with which packaging products of the above-mentioned structure can be manufactured with a width of less than 15 cm.

In particular because of the complex drive kinematics design described above in WO 95/31296 A1, such an apparatus cannot be easily redesigned in such a way that the high demand for small paper packaging products and associated packaging product manufacturing apparatus delimiting their installation space can be satisfied.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a schematic side view of an exemplary embodiment of an apparatus according to the disclosure;

FIG. 2 a schematic side view of an exemplary embodiment of an apparatus according to the disclosure;

FIG. 3 a schematic representation of an exemplary embodiment of a packaging product according to the disclosure;

FIG. 4 a perspective sectional view of an exemplary embodiment of the apparatus according to the disclosure;

FIG. 5 a schematic side view of an exemplary embodiment of an output device of an exemplary embodiment of the apparatus according to the disclosure;

FIG. 6 another exemplary embodiment of an output device;

FIG. 7 another exemplary embodiment of an output device;

FIG. 8 another exemplary embodiment of an output device;

FIGS. 9-10 an exemplary embodiment of an output device in perspective view and top view;

FIGS. 11-12 an exemplary embodiment of an output device in perspective view and front view;

FIG. 13: an exemplary embodiment of an output device in perspective view;

FIGS. 14-19 various views of an exemplary embodiment of an apparatus according to the disclosure, in which the output device is shown in various operating positions;

FIGS. 20, 21 further views of an exemplary embodiment of an apparatus according to the disclosure;

FIG. 22 a perspective view of the separating station of the apparatus of FIGS. 4 and 21;

FIGS. 23-25 perspective partial sectional views of the apparatus from FIGS. 4 and 21 in different operating positions;

FIG. 26 a schematic front view of a cutter of the separating station of FIG. 22; and

FIG. 27 a schematic partial view of the interaction of the cutter and the counter cutter of the separating station from FIG. 22.

The exemplary embodiments of the present disclosure will be described with reference to the accompanying drawings. Elements, features and components that are identical, functionally identical and have the same effect are-insofar as is not stated otherwise respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the present disclosure is to overcome the disadvantages of the prior art, in particular to improve an apparatus for producing a three-dimensional packaging product from a web-like paper raw material in such a way that the risk of a paper jam is reduced and/or an existing paper jam can be distanced more easily and/or that it is optimized in terms of force flow and/or installation space and/or that a clean separation of packaging products is ensured more reliably.

Accordingly, an apparatus is provided for producing a three-dimensional packaging product, such as a cushioning product, from a web-shaped raw material, such as a single-or multi-layered paper web, in particular from paper. For ecological reasons in particular, recovered paper is increasingly being used for the paper material, although it is difficult to deform due to its inhomogeneity, especially if the three-dimensional packaging product is always to be manufactured uniformly and as simply and economically as possible. The base material web can be made from paper, such as recycled paper, in particular recovered paper and/or 100% recyclable paper, which can be produced without chemical ingredients. Recycled paper is in particular paper materials with a low proportion (less than 50%) of paper material containing fresh fibers. For example, paper materials containing 70% to 100% recovered paper are used. The recycled paper for the purposes of the present disclosure can be paper material which can have a tensile strength index along the machine direction of at most 90 Nm/g, preferably a tensile strength of 15 Nm/g to 60 Nm/g, and a tensile strength index transversely to the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or the tensile strength index. Additionally, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the burst index. Furthermore, the packaging material has a mass per unit area of in particular 40 g/m2 to max. 140 g/m2. The raw material can be in the form of a roll of web material or a zigzag-folded stack of packaging material, also known as a leporello-stack.

In principle, the apparatus can be dimensioned and arranged in such a way that it is miniaturized, i.e. it is significantly smaller than corresponding apparatus from the prior art and/or is capable of producing significantly smaller packaging products. This allows the demand for small packaging products to be satisfied. On the other hand, apparatuses according to the disclosure meet the demand for increasingly smaller available storage areas for such packaging product preparation apparatuses. For example, the rule of thumb for the overall dimensions of apparatus according to the disclosure is that they must not exceed the outer dimensions of a standard industrial pallet. For example, apparatus according to the disclosure have an overall dimension of less than 650 mm in length in the conveying device, less than 450 mm in width transversely to the conveying device and less than 300 mm in height transversely to the conveying and width direction. The apparatus according to the disclosure can be arranged to produce small or miniature packaging products or cushions. Such small or miniature packaging products may have a length in the conveying device of less than 30 mm, a width of less than 120 mm, in particular in the portion of 80 to 90 mm, and a height of less than 40 mm, in particular in the portion of 20 to 30 mm.

The apparatus may comprise a preforming station which deforms the raw material into a three-dimensional intermediate product with at least one crumple cavity extending in the web direction. In an exemplary embodiment of the apparatus, the intermediate product can essentially correspond in shape to the final packaging product. The intermediate product is then used to produce the packaging product. In an exemplary embodiment, the preforming station may comprise a funnel-like turn-in or rolling-in device, which turns or rolls in the paper web laterally in the transverse direction as it is conveyed into the apparatus, so that the longitudinal edges of the paper web, which are provided for example by means of a leporello stack source, are folded over one another essentially in the center of the paper web. In the conveying direction of the raw material, the preforming station can be followed by a deforming station, in particular an embossing and/or perforating station, with two carrier rollers, in particular embossing and/or deforming wheels, which interlock in a deforming area in order to deform the folded or rolled-up raw material web into the cushioning product. This creates a central fastening and/or deformation zone in the raw material. This specific cushioning product may comprise a substantially central deformation zone extending in the longitudinal direction, in particular an embossing and/or perforation zone, which is adjoined in the transverse direction by two lateral hollow crumple zones, the lateral end of which also forms the end of the cushioning product. In this respect, the apparatus can produce a paper cushioning product that is essentially dumbbell-shaped in cross-section.

The apparatus further may comprise a separating station following the preforming station in the conveying direction of the raw material, which separates a packaging product of a desired length from the raw material. Cutting devices and means commonly used for the separating station can be considered.

Furthermore, the apparatus according to the disclosure may comprise an output device adjoining the separating station in the conveying direction of the raw material and having a pair of continuous conveyors located opposite one another for discharging the separated packaging product from the apparatus. The continuous conveyors can, for example, comprise conveyor belts. The continuous conveyors can basically be characterized by a continuous discharge movement. The continuous conveyors can be arranged in such a way that a section of the preformed raw material that is in front of the separating station is already transferred to the continuous conveyors and is gripped by them, so that they experience a conveying force away from the separating station. As soon as the separation process is complete, the continuous conveyors convey the separated packaging product further in the conveying direction, in particular in the direction of an output opening where the packaging products can be removed, output or ejected. The continuous conveyors delimit a discharge channel between them, through which the packaging products are transported. Generally, the continuous conveyors delimit the discharge channel vertically upwards and downwards. Lateral channel limiting elements can also be provided. In an exemplary embodiment of the continuous conveyors as conveyor belts, the conveyor belts can each be bearing on or guided by two reversing rollers, one of which can be driven by a motor to generate the conveying force.

According to a first aspect of the present disclosure, one continuous conveyor is movably mounted relative to the other continuous conveyor. This enables access between the continuous conveyors, in particular in the discharge channel. Thus, in the event of a paper jam and/or in the event of maintenance, it is possible to easily reach into the interior of the apparatus in the portion of the output device in order to remove the paper jam or to carry out the maintenance measures. For example, it is possible for the upper continuous conveyor to be movably mounted relative to the lower continuous conveyor. The movable bearing can be realized, for example, via a translational displacement movement or a rotational swivel movement. For example, one of the two continuous conveyors can be extended and retracted from the apparatus or from the output device like a drawer. The apparatus can also be provided with a detachable fastening device, by means of which the continuous conveyors are attached to each other, particularly when the apparatus is in an operating state, and are secured against being distanced from each other. The fastening device can, for example, comprise a latching, clamping, screw connection or the like.

In an exemplary embodiment of the apparatus according to the disclosure, one, in particular the upper, continuous conveyor is pivotable relative to the other, in particular the lower, continuous conveyor. The pivoting bearing of the continuous conveyor has proven to be advantageous, particularly with regard to ease of operation and/or a space-saving means of accessing the interior of the output device. For example, the continuous conveyor can be pivotably mounted in such a way that the pivotable continuous conveyor can be pivoted beyond a 90° position with respect to the other continuous conveyor. For example, a pivoting movement amplitude of approximately 150° to 170° can be created. The large movement amplitudes have proven to be advantageous in that the largest possible engagement range in the apparatus, in particular the output device, is created. The pivotable movement can, for example, be designed in such a way that the discharge channel delimited by the continuous conveyors is completely uncovered. Access to jammed or wedged or otherwise blocked packaging products is possible at any point in the discharge channel. Furthermore, all other components inside the output device can be reached.

In an exemplary embodiment of the apparatus, a swiveling direction of the pivotable continuous conveyor is oriented in the conveying direction of the raw material. In an exemplary embodiment, the pivotable continuous conveyor is guided around at least two reversing rollers and is pivotable with respect to the conveying direction around the downstream or around the upstream orientated reversing roller. The swiveling of the continuous conveyor in the conveying direction, i.e. still at the front, has the advantage that a collision with the other components of the apparatus according to the disclosure, which are all located upstream of the output device, is excluded.

According to an exemplary embodiment of the present disclosure, one of the continuous conveyors, in particular the pivotable continuous conveyor, is mounted in a floating manner. The floating mounting can, for example, be realized via a spring pre-tension. On the one hand, the floating mounting of one of the continuous conveyors can exert a certain pre-tensioning force on the packaging products so that they can be reliably gripped and conveyed away. Another advantage is that it is possible to react to fluctuations or differences in the dimensions of the packaging product transversely to its length and width, i.e. its height. Furthermore, it has been found that in the apparatus according to the disclosure, in which one of the continuous conveyors is movably mounted relative to the other continuous conveyors, the floating mounting in the operating or assembly state compensates for assembly inaccuracies. This is because the movability of one continuous conveyor relative to the other continuous conveyor guides the arrangement of the continuous conveyors in relation to one another to be subject to assembly inaccuracies in the assembled state, which is particularly noticeable when the relative movements of the continuous conveyors are carried out manually. However, the floating mounting has also proven to be advantageous for the mechanical control of movability. This means that the desired discharge channel geometry can be set reliably in any case or can be set automatically via the floating mounting.

According to an aspect of the present disclosure, which can be combined with the preceding aspects of exemplary embodiments, there is provided an apparatus for producing a three-dimensional packaging product from a web-shaped raw material. The apparatus may be formed according to one of the aspects or exemplary embodiments described above. In order to avoid repetition, reference is made to the preceding embodiments with regard to the components from the generic term.

According to the second aspect, the output device has an upper continuous conveyor and a lower continuous conveyor opposite the upper continuous conveyor. Between them, the continuous conveyors, which can be formed in accordance with the embodiments described above, form and delimit a discharge channel defining a conveying path.

According to an aspect of the disclosure, the upper continuous conveyor projects beyond the lower continuous conveyor in a direction opposite to the conveying direction of the raw material. It has been recognized that, particularly in the production of particularly short packaging products of less than 30 mm in length, one cause of packaging jams is that the packaging products do not enter the discharge channel formed between the continuous conveyors reliably enough, but instead, for example in the event of a collision with an upstream packaging product, stand upright and leave the output device upstream via the upper continuous conveyor after the separating station. By extending the upper continuous conveyor to the separating station, this effect can be counteracted, further reducing the risk of material jams.

According to an exemplary embodiment of the apparatus according to the disclosure, the upper continuous conveyor extends against the conveying direction at least as far as the separating station and/or is guided around a reversing roller on the separating station side, the axis of rotation of which lies upstream of the separating station in the conveying direction. In particular, the axis of rotation is located upstream in the conveying direction at the point at which the packaging product is separated from the raw material web. This separation point can be defined by the cutting action at which a cutter or knife of the separating station cuts through the preformed raw material. This design can reliably exclude the possibility of packaging products distancing themselves from the conveying path and not entering the discharge channel.

According to an aspect of the present disclosure, which can be combined with the preceding aspects and exemplary embodiments, an apparatus for producing a three-dimensional packaging product from a web-shaped raw material is provided. The apparatus can be designed according to one of the embodiments described above or according to one of the exemplary embodiments described above. With regard to the features from the generic term, reference is made to the preceding embodiments in order to avoid repetition.

The preforming station deforms the raw material into a three-dimensional intermediate product with two lateral crumple cavities extending in the web direction and a central fastening and/or deformation zone extending in the web direction.

According to an aspect of the present disclosure, at least one continuous conveyor is arranged and/or dimensioned to engage between the crumple cavities of the separated packaging product and to make conveying contact with the central fastening and/or deformation zone. In the central fastening and/or deformation zone, overlapping material web sections are bound together. This can be done, for example, by a pair of meshing embossing and/or perforating wheels connected to the preforming station, which are adapted to emboss and/or perforate the overlapping material web sections. An interlocking structure can be created between the overlapping material web sections, which are coupled together in this way. For example, the continuous conveyor only makes conveying contact with the central fastening and/or deformation zone. In other words, the continuous conveyor can be dimensioned so that it is free from contact with the lateral crumple cavities in the conveyor contact engagement. This can mean that a width of the continuous conveyor dimensioned transversely to the conveying direction is smaller than the smallest distance between the lateral crumple cavities. For example, a width of the central fastening and/or deformation zone is less than 30 mm, in particular between 20 mm and 25 mm. In prior art apparatus with continuous conveyors for discharging the packaging products produced with crumple cavities, it has been recognized that the conveyor contact with the crumple cavities sometimes results in them being damaged or pressed in again, which has a detrimental effect on their cushioning function, which is caused in particular by the voluminous design of the crumple cavities. The cushioning properties of the packaging product can be adversely affected by the compression of the crumple cavities.

In an exemplary embodiment of the apparatus according to the disclosure, the continuous conveyor has a shape-matched conveying surface with respect to the fastening and/or deformation zone for form-fit gripping of the packaging product. The central fastening and/or deformation zone can be created, for example, by a pair of embossing and/or deformation wheels meshing into one another. A mountain-valley structure, in particular a wave structure, alternating in the conveying direction can be introduced into the conveying surface. The mountain-valley structure gives the packaging product a certain stability and resistance to external influences. Furthermore, the continuous conveyor can have a surface with reduced frictional resistance. Examples of suitable materials are polyurethane, rubber, PVC, TPU, PUR, caoutchouc or similar. For example, the coefficient of friction is in the portion of 0.1-0.8 in relation to the contact between the paper material and the surface of the continuous conveyor.

According to an aspect of the present disclosure, which can be combined with the preceding aspects and exemplary embodiments, an apparatus for producing a three-dimensional packaging product from a web-shaped raw material is provided. The apparatus can be designed according to one of the embodiments described above or according to one of the exemplary embodiments described above. With regard to the features from the generic term, reference is made to the preceding embodiments in order to avoid repetition.

The apparatus according to the further aspect of the disclosure further may comprise a pair of meshing embossing and/or perforating wheels adjoining the preforming station in the conveying direction of the raw material, which are adapted to bind together overlapping raw material web sections along a fastening and/or deformation zone extending in the web direction. The embossing and/or perforating wheels can be adapted to emboss and/or perforate the overlapping material web sections. An interlocking structure can be created between the overlapping material web sections, which are coupled together in this way.

Furthermore, the apparatus may comprise a separating station following the embossing and/or perforating wheels in the conveying direction of the raw material, which separates a packaging product of a desired length from the raw material. Cutting devices and means commonly used in generic devices can be considered for the separating station.

Finally, the apparatus also may comprise an output device adjoining the separating station in the conveying direction of the raw material, with a pair of continuous conveyors facing each other for discharging the separated packaging product. The continuous conveyors can, for example, comprise conveyor belts. The continuous conveyors can be characterized by a continuous conveying movement. The continuous conveyors can be arranged in such a way that a section of the preformed raw material that is in front of the separating station is already transferred to the continuous conveyors and is gripped by them, so that they undergo a conveying force away from the separating station. As soon as the separation process is complete, the continuous conveyors convey the separated packaging product further in the conveying direction, in particular in the direction of an output opening where the packaging products can be removed, output or ejected. The continuous conveyors delimit a discharge channel between them, through which the packaging products are transported. As a rule, the continuous conveyors delimit the discharge channel vertically upwards and downwards. Lateral channel limiting elements can also be provided. In an exemplary embodiment of the continuous conveyors as conveyor belts, the conveyor belts can each be mounted on or guided by two reversing rollers, one of which can be motor-driven to generate the conveying force.

According to an aspect of the disclosure, the embossing and/or perforating wheels and the continuous conveyors are driven by the same motor. The fact that only one motor is required for embossing and/or perforating wheels and for the continuous conveyors means that a cost-effective apparatus can be created. A further advantage exists in particular with regard to the required miniaturization or the production of small-sized packaging products. By providing only one motor, components can be saved so that the required installation space of the apparatus can be reduced. According to the disclosure, a particularly compact packaging product manufacturing device can be provided.

In an exemplary embodiment of the apparatus, the embossing and/or perforating wheels and the continuous conveyor have drive shafts. In particular, the embossing and/or perforating wheels are mounted on drive shafts. The continuous conveyors can also be mounted on drive shafts which are realized, for example, via reversing rollers around which the continuous conveyors are guided. For example, the drive shafts of the embossing and/or perforating wheels and the drive shafts of the continuous conveyors are coupled to each other via a traction drive, in particular synchronized with each other. The traction drive can, for example, be a belt, a chain or the like. On the one hand, the traction drive makes it particularly easy to transmit power from the motor to the various pick-ups. On the other hand, the synchronization of embossing and/or perforating wheels and continuous conveyors can be easily set or adjusted when using traction drives. For example, a force pick-up sequence is defined in such a way that the drive shaft of the embossing and/or perforating wheels transmits the drive force to the continuous conveyors. In other words, the force pick-up sequence can be designed as a series connection. If the embossing and/or perforating wheels are not driven by the motor, the continuous conveyors are not driven either. In an exemplary embodiment, the traction drive of the continuous conveyors takes the driving force from the motor at the drive shaft of at least one of the perforation and/or embossing wheels. Alternatively, the continuous conveyors may have a separate motor or be driven by a separate motor that is decoupled from the motor of the embossing and/or perforating wheels.

According to an exemplary embodiment of the apparatus according to the disclosure, the apparatus, in particular the output device, may comprise an output device housing with a delivery opening for the packaging products produced. The opening cross-section of the delivery opening can be shaped according to an outer contour of the packaging products. In simplified terms, the delivery opening may have a dumbbell-shaped opening cross-section, which is shaped and dimensioned laterally according to the lateral crumple cavities of the packaging product and centrally according to the central deformation and/or fastening zone of the packaging product. The opening cross-section can, for example, be formed by the drive device housing structure itself. Alternatively, the inner side of the output device housing can have guiding or channel limiting structures that extend into the conveying path, so that the opening cross-section of the output device also reflects the shape of the packaging product. According to an exemplary embodiment of the apparatus according to the disclosure, the delivery opening may comprise two lateral crumple cavity passages for the crumple cavities and a fastening and/or deformation zone passage connecting the crumple cavity passages for the fastening and/or deformation zone of the packaging products. The crumple cavity passages have a curved, almost round cross-section, while the deformation and/or fastening zone passage is angular, in particular rectangular, in shape.

According to an exemplary embodiment of the apparatus according to the disclosure, an imaginary inner circle of the crumple cavity passages has a diameter of at least 30 mm, in particular at least 35 mm, and/or of at most 40 mm and/or a maximum height of the fastening and/or deformation zone passage is 20 mm.

The idea of adapting the delivery opening to the outer contour of the packaging product to be produced is generally to additionally avoid the formation of paper jams. By adapting the delivery opening and/or the conveyor channel delimited by the continuous conveyors to the outer contour of the packaging products being produced, the tendency for paper jams is significantly reduced, as it is much more difficult for the packaging products to become wedged or jammed within the conveyor channel. Another advantage is that reshaping takes place in the portion of the discharge channel and/or in the portion of the delivery opening. The shape of the cushioning product produced in the preforming station and possibly the subsequent embossing and/or perforating wheels can still change slightly, particularly during the separation process, which can be compensated for by reshaping by means of the discharge channel and/or the delivery opening. Another advantage is that the delivery opening serves as an optical indicator for the shape of the packaging product to be produced. Users operating the machine know from the shape of the delivery opening what cross-sectional shape the packaging product being produced will have.

In an exemplary embodiment of the apparatus according to the disclosure, the continuous conveyors are dimensioned in relation to the packaging products to be produced in such a way that they protrude by at least 0.5 cm at both lateral ends of a separated packaging product. It has proven to be advantageous if the width of the continuous conveyors exceeds the width of the packaging products to be produced. In an alternative embodiment, it is conceivable to make the overall dimensions of the discharge opening 10 mm to 20 mm smaller than the width of the packaging product. In this way, for discharging the packaging products, a transverse compression can also take place, which can provide a certain increase in stability and/or can guide to a further reduction in the packaging product size. This can be selected or adjusted depending on the requirements of the packaging products, for which purpose the delivery opening can, for example, have means for adjusting the width of the opening cross-section of the delivery opening.

According to an exemplary embodiment of the present disclosure, at least one continuous conveyor has at least two conveyor sections, in particular of the same design and distributed transversely to the conveying direction. The conveyor sections can be adapted to come into conveying contact with a respective crumple cavity, extending in the web direction, of the preformed raw material or of the separated packaging product. For example, the two conveyor sections engage exclusively with the crumple cavities. In an exemplary embodiment, the distance between the at least two conveyor sections is matched to a packaging product width. Furthermore, the width of the at least two conveyor sections in the transverse direction can be smaller than the width of the crumple cavities. An advantage of this embodiment is, for example, that the arrangement of the conveyor track sections within the conveyor channel and their coordination with the packaging products can be subject to a certain tolerance, since the conveyor track sections are intended to come into contact with the crumple cavities projecting downwards and upwards in the vertical direction, which project so far from the remaining components of the packaging product that contact by the continuous conveyors can be ensured in a simple manner.

In an exemplary embodiment, the apparatus according to the disclosure may comprise sensor technology which is associated with at least one of the continuous conveyors and is arranged to detect a deformation and/or a change in position of the continuous conveyor in order to anticipate or detect a material jam. It has been found that parameters relating to the operation, shape and/or position of the continuous conveyor can be used to draw conclusions about an existing material jam or to predict an imminent material jam. For example, the position, shape and/or ideal operation of the continuous conveyors can be calibrated, recorded during initialization and/or taken from a database. If excessive deviations in relation to the parameters are identified during operation of the packaging production device, the sensor system can be adapted to display an error message, lead into maintenance measures, stop operation and/or move the movably mounted continuous conveyor from its operating position to a maintenance position, in particular to swivel it. In an exemplary embodiment of the apparatus according to the disclosure, the continuous conveyor is formed as a conveyor belt and a sensor is assigned to the conveyor belt in such a way that the sensor detects a deflection of the conveyor belt. In this embodiment, the apparatus according to the disclosure utilizes the knowledge that material accumulates within the discharge channel in the event of a material jam and ultimately exerts pressure on the conveyor belt, which guides the conveyor belt to deflect. In an alternative embodiment, in which the continuous conveyor is also formed as a conveyor belt and is movably mounted relative to the preforming station, a sensor can be assigned to the conveyor belt in such a way that the sensor detects a movement of the conveyor belt relative to the preforming station or to the opposite conveyor belt. This embodiment can be easily combined with a movable mounting of the conveyor belt, for example. The material accumulating in the discharge channel in the event of a material jam can then guide the conveyor belt away. Furthermore, it is possible that the sensor may comprise a load cell which, in the case of a fixed conveyor belt, can detect a force applied to the conveyor belt by material accumulating inside the discharge channel.

In an exemplary embodiment of the present disclosure, the continuous conveyors delimit a conveying path between them and are each guided around at least two reversing rollers. One downstream reversing roller of each of the two continuous conveyors can be arranged at the same height as that of the other continuous conveyor with respect to the conveying direction of the raw material. Furthermore, the continuous conveyors can be arranged relative to each other in such a way that a cross-section of the conveying path decreases from an end of the conveying path on the separation station side in the conveying direction of the raw material to a minimum in the portion of the most downstream reversing rollers. The conveying path or discharge channel delimited by the continuous conveyors can thus taper in the conveying direction, in particular continuously decreasing down to the discharge opening in the discharge device housing.

In another exemplary embodiment, the lower continuous conveyor is orientated essentially horizontally and/or essentially parallel to the conveying direction of the preformed raw material at the level of the separating station. In this way, a reliable transfer of the preformed raw material, which is leading in relation to the cutting edge of the packaging product, and of the packaging products themselves to the lower continuous conveyor is guaranteed. After being cut in the separating station, the packaging products do not first have to fall downwards from the separating station in a vertical direction under the influence of gravity, but instead immediately enter into conveying engagement with the lower continuous conveyor. Incorrect positioning or uprighting of the packaging products within the discharge channel due to falling can thus be avoided. This can significantly reduce the risk of material jams.

According to an exemplary embodiment of the apparatus according to the disclosure, the lower continuous conveyor is arranged essentially in alignment with a lower conveyor path limitation in the portion of the separating station. This aligned arrangement enables a seamless transfer of the packaging products from the separating station to the output device.

In an exemplary embodiment of the apparatus according to the disclosure, the separating station has a cutter which is guided in such a way that it translationally cuts through the raw material transversely to the conveying direction, counter to the direction of gravity, during cutting engagement. A cutting engagement is understood in particular to be the point in time at which the cutter plunges into the raw material web. In cutting engagement, the cutter can plunge into the raw material web over its entire depth, i.e. its longitudinal extent transversely to the conveying direction. In other words, the cutter can run in a straight line in this depth direction, which is orientated parallel to the width of the raw material web. Due to the translational penetration of the raw material web in the cutting engagement transversely to the conveying direction, the raw material web is in particular subjected to a cutting force transversely to the conveying direction. In particular, this cutting force can cause the raw material web to be tensioned in the conveying direction before the actual cutting. For example, the cutter can be guided in such a way that it travels through the raw material web in a translational manner. Cutting through the raw material web against the direction of gravity has proven to be advantageous in that the weight of the raw material web to be cut is thus orientated against the translational cutting direction. Furthermore, it is thus possible to design the apparatus in a modular and/or very compact manner. The fact that the direction of translational movement is orientated from bottom to top, i.e. against the direction of gravity, means that all drive, motor and gear components can be arranged at the bottom of the apparatus, in particular below a conveying path leading through the apparatus, along which the raw material web is conveyed. This ensures that free access to all components processing the raw material web is possible from above, in particular without stationary operating, gear or motor components being in the way. These are then accessible from below in a compact and, if necessary, spatially organized manner. The cutter works like a guillotine. The cutting movement direction transversely to the conveying direction can also be orientated transversely to the two-dimensional extension of the raw material web, which is defined by the conveying direction and a width direction of the raw material web orientated transversely to the conveying direction.

Because the continuous conveyor is formed and adapted for discharging the separated packaging product, the conveying process is frictionally engaged between the respective continuous conveyor and the packaging product. The packaging product is subjected to a predetermined clamping force between the continuous conveyors or by the at least one continuous conveyor. Furthermore, the clamping force and the frictional connection are dimensioned in such a way that the packaging product is held against the influence of gravity, for example, when the delivery device motor is switched off. The first end region of the packaging product thus protrudes from the delivery opening, while the second end region of the packaging product is held in a frictionally engaged manner by the continuous conveyor. It is thus possible for the operator to pull the packaging product produced out of the delivery opening and release it from the continuous conveyor by simply gripping it.

Furthermore, and as described at the beginning, a sensor is provided in the portion of the continuous conveyor which detects, for example, the movability of the conveyor belt or, alternatively, the movement of the continuous conveyor. Such a movement is triggered by the user when the packaging product is removed from the delivery opening, because the packaging product is in frictional engagement with the continuous conveyor.

A first sensor is arranged and adapted to detect the movability of the continuous conveyor in response to and/or during manual removal of the packaging product from the delivery opening. The sensor is connected to a control device of the apparatus, and all drive motors, but at least the output device motor of the continuous conveyor, the drive motor of the conveying device and the drive motor of the separating station, are also connected to the control device of the apparatus. Furthermore, a programmable logic controller is a component of the control device of the apparatus, which has an executable program. An operating unit is also provided, which is connected to the control device and by means of which the user can make settings and select operating modes. A first essential operating mode of the apparatus is the so-called removal mode. Another operating mode of the apparatus is the so-called ejection mode.

If the first sensor detects a movability of the continuous conveyor, caused by a manual removal of the packaging product from the delivery opening, the signal of the first sensor is evaluated by the control device and the executable program carries out a further production process of another packaging product in such a way that this also protrudes with the first end area out of the delivery opening, while the second end area of this further packaging product is now held in a frictionally engaged manner by the continuous conveyor. As soon as this further packaging product is also manually removed from the delivery opening by the user, the first sensor detects this again and the executable program restarts the production process for a further packaging product. This type of production process corresponds to the operating mode of the removal mode because the user removes the packaging products from the delivery opening.

The signal from the first sensor has no significant function in the other operating mode, the so-called ejection mode. This is because in this operating mode, a number of packaging products are continuously produced and ejected from the apparatus through the delivery opening by means of the continuous conveyor.

The first sensor can be formed as a reflective light barrier, wherein the light beam is in contact with the surface of the movable element of the continuous conveyor. In an exemplary embodiment, the first sensor is formed as an optical motion sensor.

Another sensor can be used as an alternative to the first sensor. In one embodiment of another sensor, this is also formed as a light barrier sensor. A reflective light barrier sensor can also be used here. Alternatively, the other sensor is formed by a light barrier sensor with a transmitter unit and a receiver unit. In another embodiment, the other sensor is formed as a capacitive sensor.

The other sensor is now formed and adapted to recognize whether a packaging product is present in the portion of the continuous conveyor and/or in the portion of the delivery opening or has been removed by the user, for example. Here too, this sensor is connected to the control unit as described above for the first sensor. The operating mode of the removal mode is also possible in this combination. The sensor itself detects the presence of a packaging product in the discharge channel and is arranged in the portion of the continuous conveyor. If the operating mode of the removal mode is activated and the sensor detects the absence of a packaging product, this triggers the generation of another packaging product and makes it available to the user for removal at the delivery opening. It should also be mentioned that the elements of the continuous conveyor that grip the packaging product have a gap width that tapers in the conveying direction. This is particularly advantageous in counteracting an operational fault such as a paper jam, because the packaging product is picked up and gripped by the continuous conveyor in a funnel-like manner coming from the separating station arranged upstream. If the continuous conveyor or continuous conveyors are formed as a conveyor belt, the conveyor belt sections gripping the packaging product do not run parallel, but taper in the conveying direction, so that at least part of the funnel shape is formed and a tapering gap width results in the conveying direction. If the continuous conveyor is formed as a wheel mechanism, the wheels of the continuous conveyor itself form the funnel-like gap that tapers in the conveying direction for picking up and gripping as well as for holding and ejecting or for conveying the packaging product further.

According to an aspect of the present disclosure, which can be combined with the preceding aspects and exemplary embodiments, there is provided a packaging product, in particular a paper packaging product, which is produced from a web-shaped raw material by means of an apparatus formed according to one or more of the aspects and/or embodiments of the disclosure, and/or whose width measured transversely to the longitudinal web direction is less than 12 cm and/or whose length in the longitudinal web direction is less than 30 cm. It has been found that conventionally, there is a great need for miniature packaging products, which can be satisfied by the packaging products according to the disclosure.

According to an aspect of the present disclosure, which can be combined with the preceding aspects and exemplary embodiments, there is a system with an apparatus designed in accordance with one of the aspects described above or one of the exemplary embodiments described above for producing a three-dimensional packaging product from a web-shaped raw material and a raw material supply arranged in particular in the conveying direction upwards of the apparatus. The raw material supply can be in the form of a raw material web roll, in particular in the form of a coreless roll, or a leporello-stack. For example, a web-shaped raw material extends from the raw material web supply into the apparatus, in particular into its preforming station.

According to an aspect of the present disclosure, which can be combined with the preceding aspects and exemplary embodiments, an apparatus is provided for producing a three-dimensional packaging product, such as a cushioning product, from a web-shaped raw material, such as a single-or multi-layered paper web, in particular from paper. The creation of a three-dimensional packaging product is to be understood in particular as the conversion of a web-shaped raw material into a state with a greater extension in the raw material thickness direction compared to the raw material. For ecological reasons in particular, recovered paper is increasingly being used for the paper material, but due to its inhomogeneity it is difficult to deform, especially if the three-dimensional packaging product is always to be manufactured uniformly and as simply and economically as possible. The base material web can be made from paper, such as recycled paper, in particular recovered paper and/or 100% recyclable paper, which can be produced without chemical ingredients. Recycled paper is in particular paper materials with a low proportion (less than 50%) of paper material containing fresh fibers. For example, paper materials containing 70% to 100% recovered paper are used. The recycled paper for the purposes of the present disclosure can be paper material which can have a tensile strength index along the machine direction of at most 90 Nm/g, preferably a tensile strength of 15 Nm/g to 60 Nm/g, and a tensile strength index transversely to the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or the tensile strength index. Additionally, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the burst index. Furthermore, the packaging material has a mass per unit area of in particular 40 g/m2 to max. 140 g/m2. The raw material can be in the form of a roll of web material or a zig-zag folded stack of packaging material, also known as a leporello-stack.

In principle, the apparatus can be dimensioned and arranged in such a way that it is miniaturized, i.e. it is significantly smaller than corresponding apparatus from the state of the art and/or is capable of producing significantly smaller packaging products. This allows the demand for small packaging products to be satisfied. On the other hand, apparatuses according to the disclosure meet the demand for increasingly smaller available storage areas for such packaging product preparation apparatus. For example, the rule of thumb for the overall dimensions of apparatus according to the disclosure is that they must not exceed the outer dimensions of a standard industrial pallet. For example, apparatus according to the disclosure have an overall dimension of less than 650 mm in length in the conveying device, less than 450 mm in width transversely to the conveying device and less than 300 mm in height transversely to the conveying and width direction. The apparatus according to the disclosure can be arranged to produce small or miniature packaging products or cushions. Such small or miniature packaging products may have a length in the conveying device of less than 30 mm, a width of less than 120 mm, in particular in the portion of 80 to 90 mm, and a height of less than 40 mm, in particular in the portion of 20 to 30 mm.

The apparatus may comprise a preforming station adapted to form the raw material by radially inwardly folding lateral raw material web sections of the raw material two lateral crumple cavities extending in the web direction and a central overlap zone extending in the web direction, in which the raw material web sections folded around overlap. The raw material can be deformed into a three-dimensional intermediate product with at least one crumple cavity extending in the web direction. In an exemplary embodiment of the apparatus, the shape of the intermediate product can essentially correspond to that of the final packaging product. The intermediate product is then used to produce the packaging product. In an exemplary embodiment, the preforming station may comprise a funnel-like turn-in or rolling-in device, such as a convergence funnel, which turns-in or rolls-in the paper web laterally in the transverse direction as it is conveyed into the apparatus, so that the longitudinal edges of the paper web, which are provided for example by means of a leporello stack source, are essentially turned-in one above the other in the center of the paper web.

The preforming station also may comprise a take-off device for drawing in and conveying the raw material, in particular from a raw material supply that can be arranged upstream of the forming station. The take-off device may comprise a pair of continuous conveyors, such as conveying wheels or conveying rollers, located opposite each other. For example, the conveying wheels or conveying rollers can be pre-tensioned against each other, in particular spring pretensioned, so that a pre-tensioning force, in particular an elastic one, is exerted on the raw material web. The continuous conveyors can basically be characterized by a continuous conveying movement. The continuous conveyors convey the raw material in the conveying direction, in particular in the direction of a discharge opening at which the packaging products can be removed or discharged or ejected, in particular with frictional engagement. The continuous conveyors delimit a conveyor channel between them, through which the raw material is transported. As a rule, the continuous conveyors delimit the conveyor channel at least partially in the vertical direction upwards and downwards. Lateral channel limiting elements can also be provided.

Furthermore, the apparatus may comprise a deformation station connected to the preforming station in the conveying device of the raw material, which can be formed by a pair of embossing and/or deformation wheels, which are adapted to bind overlapping material web sections to one another along a fastening and/or deformation zone extending in the web direction and to convey the preformed raw material. The embossing and/or deformation wheels interlock in the fastening and/or deformation zone in order to deform the wrapped or rolled-up raw material web into the cushioning product. This creates the central fastening and/or deformation zone in the raw material. This specific cushioning product may comprise a substantially central deformation zone extending in the longitudinal direction, in particular an embossing and/or perforation zone, which is adjoined in the transverse direction by two lateral cavity crumple zones, the lateral end of which also forms the end of the cushioning product. In this respect, the apparatus can produce a paper cushioning product that is essentially dumbbell-shaped in cross-section.

According to the first aspect of the present disclosure, the apparatus also may comprise a common motor for providing a driving force for the take-off device and the embossing and/or deformation wheels. The fact that only one motor is required for embossing and/or perforating wheels and for the take-off device means that a cost-effective apparatus can be created. A further advantage exists in particular with regard to the required miniaturization or the production of small-sized packaging products. By providing only one motor, components can be saved so that the required installation space of the apparatus can be reduced. This makes it possible to provide a particularly compact packaging product production device. A force pick-up sequence is defined in such a way that the take-off device transmits the drive force to the embossing and/or deformation wheels. In other words, the force pick-up sequence can be designed as a series connection. If the take-off device is not driven by the motor, the embossing and/or deformation wheels are also not driven. The embossing and/or deformation wheels and the take-off device can be synchronized.

The longitudinal direction of the raw material web is to be understood in particular as the direction in which the raw material is drawn off during operation from the raw material supply, such as a raw material roll, in particular in the form of a coreless roll, or a leporello stack, and conveyed through the apparatus. This direction can also be referred to as the longitudinal direction of the raw material.

The raw material width direction is to be understood in particular as the direction in which the raw material extends between longitudinal edges of the web-shaped raw material. In particular, the longitudinal edges extend in the conveying direction. In particular, the raw material width direction is the direction in which the raw material is transversely compressed as it is conveyed through the forming station.

In particular, a web-shaped raw material is understood to be a raw material that extends in particular in a flat manner along the longitudinal raw material direction (conveying direction) and the raw material width direction. In particular, the web-shaped raw material extends orthogonally to a surface defined by the longitudinal raw material direction and the raw material width direction in a raw material thickness direction. In particular, the extension, in particular the thickness, of the web-shaped raw material in the raw material thickness direction is significantly smaller than the extension, in particular the width, of the web-shaped raw material in the raw material width direction. By significantly smaller is meant in particular an extension in the raw material thickness direction of at most 20%, 10%, 5%, 3%, 2%, 1% or 0.5% of the extension of the raw material in the raw material width direction.

In particular, the longitudinal raw material direction, the raw material width direction and the raw material thickness direction define a coordinate system with three mutually orthogonal directions, also known as a Cartesian coordinate system. In particular in embodiments in which the raw material is deflected, the coordinate system moves with the raw material. For example, in one embodiment, the raw material can be conveyed in a horizontal direction from the raw material supply to the apparatus. At the apparatus, the raw material can then be deflected in a horizontal direction in which it passes through the apparatus. In this case, before entering the forming station, the conveying direction corresponds to a vertical direction and the raw material thickness and width directions each correspond to horizontal directions. Within the apparatus, the conveying direction and the raw material width direction then each correspond to a horizontal direction and the raw material thickness direction to a vertical direction.

Information on features of the apparatus and its components, such as the forming station, which are given in relation to the conveying direction, raw material thickness direction and/or raw material width direction, therefore always refer to the coordinate system as it is orientated at the conveying direction height of the corresponding component or a section of the component.

Since the directions in which the raw material extends in terms of width and thickness can change and partially overlap during and after transversely compressing, the co-travelling coordinate system is determined in the state of the raw material before it is transversely compressed, in particular in the raw material supply, between the raw material supply and the apparatus or immediately before the first transversely compressing operation. In particular, the coordinate system is determined upon entering the forming station. In an example in which the raw material enters the apparatus horizontally, the conveying direction and the raw material width direction each correspond to horizontal directions that are orthogonal to one another and the raw material thickness direction corresponds to a vertical direction. If, in this example, the raw material were subsequently deflected in the vertical direction, the coordinate system would move accordingly with the raw material or the transversely compressed material, so that the raw material thickness direction and the raw material width direction would then correspond to mutually orthogonal horizontal directions and the conveying direction would correspond to a vertical direction.

In particular within the forming station, the raw material width direction can alternatively be referred to as the convergence direction. In particular, the convergence direction is orthogonal to the conveying direction and describes the direction in which the extension of the convergence channel decreases in the conveying direction, in particular due to the channel tapering in the conveying direction. Alternatively, or additionally, the raw material thickness direction can be referred to as the normal direction, particularly within the forming station. The normal direction is the direction that describes a normal line to a plane defined by the conveying direction and the convergence direction. It should be clear that all the information provided previously and subsequently about the raw material width direction and the raw material thickness direction within the apparatus, in particular the forming station, can also be provided on the basis of the convergence direction and the normal direction.

According to an aspect of the present disclosure, which can be combined with the preceding aspects and exemplary embodiments, there is provided an apparatus for producing a three-dimensional packaging product from a web-shaped raw material, comprising a preforming station adapted to form, by radially inwardly folding lateral raw material web portions of the raw material, two lateral crumple cavities extending in the web direction and a central overlap zone extending in the web direction, in which the folded raw material web portions overlap, and has a take-off device for drawing in and conveying the raw material, a pair of meshing embossing and/or perforating wheels adjoining the preforming station in the conveying direction of the raw material, which wheels are adapted to bind overlapping material web sections to one another along a fastening and/or deformation zone extending in the web direction and to convey the preformed raw material, and may comprise a common motor for providing a driving force for the take-off device and the embossing and/or perforating wheels. The apparatus may be designed according to one of the aspects described above or according to one of the exemplary embodiments described above. To avoid repetition, reference is also made in this respect to the preceding embodiments relating to the technical details of the apparatus.

According to further aspects of the disclosure, the motor has an output shaft which is orientated in the opposite direction to the conveying direction of the raw material. This makes it possible, among other things, to minimize the length of the apparatus according to the disclosure when viewed in the conveying direction of the raw material. The recess thus created in relation to the conveying direction favors the most compact possible embodiment of the apparatus, in particular while ensuring force flow-optimized force transmission.

In an exemplary embodiment of the apparatus, the motor is arranged in the conveying direction between the embossing and/or perforating wheels and the take-off device. In this way, the mounting space in the conveying direction, which is in any case required for preforming, can be effectively utilized to accommodate the common motor for the embossing and/or perforating wheels and the take-off device.

According to an exemplary embodiment of the apparatus according to the disclosure, the motor has an output shaft which directly drives a drive shaft of the take-off device. In particular, direct can be understood to mean that the drive force generated by the motor can be transmitted from its output shaft to the drive shaft of the take-off device, on which, for example, its conveying wheels or conveying rollers are rotatably mounted, without additional or separate power transmission means. This type of power transmission favors the space-saving and component-reduced design of the apparatus.

In an exemplary embodiment of the apparatus according to the disclosure, the output shaft of the motor is in meshing engagement with the drive shaft of the take-off device. In this way, power can be transmitted directly between the motor and the take-off device, in particular between the motor output shaft and the drive shaft of the take-off device. For example, the meshing engagement is realized via bevel gearing or worm gear toothing. The transmission ratio can be in the portion of 5-25, in particular 10-20, especially 15. Furthermore, the motor and planetary gear can be arranged orthogonally to the conveying direction.

In the apparatus according to the disclosure, four possible arrangements are provided in particular for driving the embossing and/or perforating wheels and the take-off device with a motor. The traction drive, which is to be designed to be force-fit and/or form-fit, can be realized, for example, by a chain, a belt, a rope or the like.

According to a first embodiment, two traction means can be provided. One traction means can be assigned to the motor and the take-off device, while the second traction means can be assigned to the motor and the embossing and/or perforating wheels. Consequently, the motor drives both the take-off device and the embossing and/or perforating wheels.

According to a second embodiment, two traction means may be present. One traction means can be assigned to the motor and the take-off device, while the second traction means can be assigned to the motor and the embossing and/or perforating wheels in such a way that the motor drives the take-off device, which in turn drives the embossing and/or perforating wheels.

According to a third embodiment, two pulling means can be provided. One traction means can be assigned to the motor and the embossing and/or perforating wheels, while the second traction means can be assigned to the embossing and/or perforating wheels and the take-off device. In this way, the motor drives the embossing and/or perforating wheels, which in turn drive the take-off device.

According to a fourth embodiment variant, only one traction means can be present, which is assigned to the motor, the embossing and/or perforating wheels and the take-off device. With a clockwise rotating drive, this drives the take-off device and the embossing and/or perforating wheels; with a counterclockwise rotating drive, this drives the embossing and/or perforating wheels and the take-off device.

The choice of drive variant depends, among other things, on the mounting space. What is important is the transmission ratio between the take-off device and the embossing and/or perforating wheels, which can be in the portion of 0.1 to 10, in particular in the portion of 1 to 2. The transmission ratio can, for example, result from the quotient of ‘number of teeth of the embossing and/or perforating wheels’ to ‘number of teeth of the take-off device’. With regard to the selected transmission ratio, the motor can, for example, have two drive discs in order to simultaneously drive the embossing and/or perforating wheels and the take-off device.

In an exemplary embodiment of the apparatus according to the disclosure, at least one, in particular exactly one, embossing and/or perforating wheel is driven by the drive via a gear transmitting the torque applied to the drive shaft of the take-off device to the embossing and/or perforating wheel. In other words, a gear is interposed between the take-off device drive shaft and the embossing and/or perforating wheel.

According to an exemplary embodiment of the present disclosure, the at least one embossing and/or perforating wheel is mounted on a further drive shaft. For example, the drive shaft of the embossing and/or perforating wheel is orientated parallel to the drive shaft of the attraction device. The orientation of the drive shafts can be arranged perpendicular to the conveying direction and perpendicular to the longitudinal extension or axis of rotation of the output shaft of the motor.

According to another exemplary embodiment, the gear is a traction drive, in particular a belt or chain drive. For example, the traction drive can couple the embossing and/or deformation wheels and the tightening device to one another, in particular synchronize them with one another. The traction drive can, for example, be a belt, a chain or the like. On the one hand, the traction drive can be used to transmit power from the motor to the various pick-ups, which is particularly easy to implement. On the other hand, the synchronization of the embossing and/or perforating wheels and the take-off device can be easily set or adjusted when using traction drives.

According to an exemplary embodiment of the present disclosure, a load strand of the traction drive is free of a deflection. It may be provided that the load strand is not guided around reversing rollers or deflection rollers. The load strand, also called the traction strand, is usually referred to as that section of the traction drive which is pulled and is tight.

In an exemplary embodiment of the apparatus according to the disclosure, the apparatus further may comprise a separating station adjoining the embossing and/or perforating wheels in the conveying direction of the raw material, which separates a packaging product of a desired length from the raw material, in particular from the intermediate product. Common cutting devices and means used in generic apparatus can be considered for the separating station.

In an exemplary embodiment of the apparatus according to the disclosure, the separating station is driven by the same motor as the embossing and/or perforating wheels and the take-off device, wherein the force pick-up sequence is determined such that the embossing and/or perforating wheels or the take-off device transmit the driving force to the separating station. In other words, the force pick-up sequence can be designed as a series connection. If the embossing and/or perforating wheels or the take-off device, depending on the force pick-up sequence, are not driven by the motor, the separating station is also not driven.

According to an aspect of the present disclosure, which can be combined with the preceding aspects and exemplary embodiment, an apparatus for producing a three-dimensional packaging product from a web-shaped raw material, comprising a preforming station which is adapted to forming two crumple cavities extending in the web direction and a central overlap zone extending in the web direction, in which the folded-over raw material web sections overlap, by radially inwardly folding lateral raw material web sections of the raw material, and having a take-off device for drawing in and conveying the raw material, a pair of meshing embossing and/or perforating wheels adjoining the preforming station in the conveying direction of the raw material, which are adapted to bind overlapping material web sections to one another along a fastening and/or deformation zone extending in the web direction and to convey the preformed raw material, a separating station adjoining the embossing and/or perforating wheels in the conveying direction of the raw material, which separates a packaging product of a desired length from the raw material, and a common motor for providing a driving force for the take-off device and the embossing and/or perforating wheels. The apparatus can be designed in accordance with one of the aspects described above or one of the exemplary embodiments described above, so that reference can be made to the preceding embodiments in order to avoid repetition.

According to further aspects of the disclosure, the apparatus may comprise a motor for providing a driving force to the separating station. The raw material and the packaging products produced are conveyed along a conveying path through the apparatus, and the motor of the take-off device and embossing and/or perforating wheels and the motor of the separating station are arranged below the conveying path. One advantage of the arrangement of the motor and gear components below the conveying path is, for example, that access from above to the components processing the packaging material is possible without being restricted by motor components, particularly stationary ones. Furthermore, this provides a kind of modularized structure for the apparatus. This can further increase the compactness of the apparatus.

According to an exemplary embodiment, the preforming station has a mounting plate, on the guide side of which, facing the conveying path, raw material conveyed along the conveying path is guided and on the mounting side of which, facing away from the conveying path, the motor for the take-off device and the embossing and/or perforating wheels and, if applicable, the motor for the separating station are arranged.

According to an exemplary further embodiment of the apparatus according to the disclosure, the take-off devices, the embossing and/or perforating wheels and the separating station are driven by a single common motor. For example, the take-off device, the embossing and/or perforating wheels, in particular exactly one embossing and/or perforating wheel, and the separating station can be coupled via a gear configured in accordance with one of the exemplary embodiments described above, such as a traction drive, for example a belt or chain drive. For example, a freewheel can be provided in the traction drive for drawing off and embossing. The freewheel can be arranged in opposite directions in the separating station. In the conveying direction, the freewheels can be set the same for drawing off, embossing and, if necessary, for discharging, which guides the raw material into the apparatus, conveying, deforming and, if necessary, discharging. By changing the direction of rotation of the motor, the take-off device, embossing and/or perforating wheels can be in freewheeling mode so that the separating station switches to the blocking direction, which means that a packaging material product can be cut off. In this reverse direction of rotation, namely the blocking direction with respect to the separating station, the embossing and/or perforating wheels and/or the take-off device are at a standstill. As a result, a particularly cost-effective and easy-to-implement drive gear technology can be implemented and no drivers or synchronizations or controls are required. The drive according to the disclosure only requires one forward and one reverse gear.

According to an aspect of the present disclosure, which can be combined with preceding aspects and exemplary embodiments, an apparatus for producing a three-dimensional packaging product from a web-shaped raw material, comprising a preforming station adapted to form two lateral crumple cavities extending in the web direction and a central overlap zone extending in the web direction by radially inwardly folding lateral web sections of the raw material, in which the folded-over raw material web sections overlap, and has a pair of conveying wheels for drawing in and conveying the raw material, and a pair of meshing embossing and/or perforating wheels adjoining the preforming station in the conveying direction of the raw material, which are adapted to bind overlapping material web sections to one another along a fastening and/or deformation zone extending in the web direction and to convey the preformed raw material.

The apparatus can be designed in accordance with one of the aspects described above or one of the exemplary embodiments described above, so that reference can be made to the relevant embodiments in order to avoid repetition.

The pair of conveying wheels can also be a pair of conveying rollers, for example, whose roller length in the direction of the axis of rotation is significantly greater than its diameter. At least one conveying wheel or conveying roller of the conveying wheel pair can be floatingly mounted, in particular spring pretensioned. The floating mounting or the spring pre-tension can be aligned in a material thickness direction orientated perpendicular to the flat extension of the raw material web, so that on the one hand it is possible to react to different raw material thicknesses or unevenness and also a certain pretensioning force can be exerted on the raw material web in order to reliably draw it off and convey it.

According to the further aspect of the present disclosure, the pair of conveying wheels and the embossing and/or perforating wheels are driven such that the pair of conveying wheels rotates at a peripheral speed at least 10% higher than the embossing and/or perforating wheels. The peripheral speed refers to the speed at the rolling surfaces of the respective wheels on the raw material web. This difference in peripheral speed results in an axial compression or shrinkage of the raw material web in the conveying direction, which guides the raw material web into a wave-like preform. This allows several technical effects to be achieved. Firstly, the material web, as already mentioned, whereby the length of the packaging products to be manufactured, which is measured in conveying directions, can be further reduced. Furthermore, the packaging products produced in this way also have a cushioning function when viewed in their longitudinal direction. In this way, an accordion-like expandable and compressible packaging product can be produced, which can be inserted into cavities of different lengths in this way. In addition, the increased peripheral speed of the conveying wheels compared to the embossing and/or perforating wheels reduces the tendency of the material web to tear within the apparatus, as the material tension in the conveying direction or longitudinal direction of the raw material web is reduced. In principle, the pair of conveying wheels and the embossing and/or perforating wheels can be controlled in such a way that the drive conveying force imparted to the raw material web by the pair of conveying wheels is greater than the drive conveying force imparted to the raw material by the embossing and/or perforating wheels. For example, this can be achieved by coupling a drive shaft of the conveying wheel pair and a drive shaft of the embossing and/or perforating wheel pair via a traction drive, wherein a force collector of the drive shaft of the conveying wheel pair has a smaller diameter than a force collector of the drive shaft of the embossing and/or perforating wheel pair. Furthermore, it is possible for the force collectors of the pair of conveying wheels and the embossing and/or perforating wheels to have the same outer diameter, but for the embossing and/or perforating wheels to have a smaller diameter than the pair of conveying wheels.

According to an alternative embodiment, the pair of conveying wheels and the embossing and/or perforating wheels are each driven by a separate motor. In this way, the corresponding speeds and thus the degree of axial shrinkage or compression of the raw material web between the pair of conveying wheels and the embossing and/or perforating wheels can be set as required. For example, this can be set so that the peripheral speed at the embossing and/or perforating wheels is 10% lower than the peripheral speed at the pair of conveying wheels.

According to an exemplary embodiment of the apparatus according to the disclosure, the pair of conveying wheels and the embossing and/or perforating wheels are driven by a common motor. In this way, an apparatus can be created which requires few components and can therefore be realized in a particularly compact manner.

In addition to the embodiments mentioned at the beginning, it should be noted that a gear is connected downstream of the motor for driving the embossing and/or perforating wheels and for driving the take-off or conveying wheels. The gear is formed as a speed reduction gear in the form of a worm gear, wherein the center longitudinal axis of the gear output shaft is at an angular offset of 90 degrees to the center longitudinal axis of the electric drive motor. For the sake of simplicity, the structural unit consisting of electric motor and gear can also be understood as a motor for the purposes of this application.

Furthermore, it is irrelevant whether the gear output shaft is formed as a hollow shaft or a solid shaft, as the gear itself or the motor-gear unit is available as a standard component from a supplier. However, it is essential that two take-off or conveying wheels are coupled to the gearbox output shaft and that the gearbox output shaft drives the take-off or conveying wheels in rotation. Because, in an exemplary embodiment, the gear is arranged between the take-off or conveying wheels and the center longitudinal axis of the motor of the motor-gear unit extends in the longitudinal direction, i.e. parallel or at least at a shallow angle and essentially parallel to the conveying path and below the conveying wheel, a particularly compact design is achieved.

However, it is also essential that the motor-gear unit drives the take-off or conveying wheels directly in an inventive manner, because this makes it possible to move the motor-gear unit into an upstream space section of the apparatus that has not been utilized in the prior art to date. Compared to the prior art, said motor-gear unit would be arranged laterally next to one of the embossing and/or perforating wheels in order to drive it directly. This very unfavorable embodiment is countered, since in an inventive manner the motor for operating the embossing and/or perforating wheels is arranged in front of these wheels with respect to the conveying direction and is moved and arranged in an inventive manner further down into the aforementioned previously unused space section of the apparatus between the preforming station and the embossing and/or perforating station.

In this advantageous embodiment, it has also been shown that an elongated section of the transmission output shaft provides a free section on which a wheel of the traction drive can be mounted. In an exemplary form, the wheel is formed as a toothed belt wheel or alternatively as a chain wheel and can be adjusted on the transmission output shaft in such a way that the traction means placed on it runs laterally past the motor and at the same time laterally past the first embossing and/or perforating wheel. The first embossing and/or perforating wheel is non-rotatably connected to the force-collecting wheel of the traction drive via a shaft.

It should also be mentioned that the gearbox output shaft drives the take-off or conveying wheels directly. Furthermore, the gearbox-side bearings of the gearbox output shaft serve both as bearings for the gearbox components and at the same time as complete or at least partial bearings for at least one of the two take-off or conveying wheels. This results in an even more compact design and further simplified assembly of the apparatus.

According to an aspect of the present disclosure, which can be combined with the preceding aspects and exemplary embodiments, there is provided a packaging product, in particular a paper packaging product, which is produced from a web-shaped raw material by means of an apparatus formed according to one or more of the aspects and/or embodiments, and/or whose width measured transversely to the longitudinal web direction is less than 12 cm and/or whose length in the longitudinal web direction is less than 30 cm. It has been found in the prior art that there is a great need for miniature packaging products, which can be satisfied by the packaging products according to the disclosure.

According to an aspect of the present disclosure, which can be combined with the preceding aspects and exemplary embodiments, a system is provided with an apparatus designed in accordance with one of the aspects described above or one of the exemplary embodiments described above for producing a three-dimensional packaging product from a web-shaped raw material and a raw material supply arranged in particular in the conveying direction upwards of the apparatus. The raw material supply can be in the form of a raw material web roll, in particular in the form of a coreless roll, or a leporello-stack. For example, a web-shaped raw material extends from the raw material web supply into the apparatus, in particular into its preforming station.

According to an aspect of the present disclosure, which can be combined with the preceding aspects and exemplary embodiments, an apparatus is provided for producing a three-dimensional packaging product, such as a cushioning product, from a web-shaped raw material, such as a single-or multi-layered paper web, in particular from paper. For ecological reasons in particular, recovered paper is increasingly being used for the paper material, although it is difficult to deform due to its inhomogeneity, especially if the three-dimensional packaging product is always to be manufactured uniformly and as simply and economically as possible. The raw material web can be made from paper, such as recycled paper, in particular recovered paper and/or 100% recyclable paper, which can be produced without chemical ingredients. Recycled paper is in particular paper materials with a low proportion (less than 50%) of paper material containing fresh fibers. For example, paper materials containing 70% to 100% recovered paper are used. The recycled paper for the purposes of the present disclosure can be paper material which can have a tensile strength index along the machine direction of at most 90 Nm/g, preferably a tensile strength of 15 Nm/g to 60 Nm/g, and a tensile strength index transversely to the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or the tensile strength index. Additionally, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the burst index. Furthermore, the packaging material has a mass per unit area of in particular 40 g/m2 to max. 140 g/m2. The raw material can be in the form of a roll of web material or a zigzag-folded stack of packaging material, also known as a leporello-stack.

In principle, the apparatus can be dimensioned and arranged in such a way that it is miniaturized, i.e. it is significantly smaller than corresponding apparatus from the state of the art and/or is capable of producing significantly smaller packaging products. This allows the demand for small packaging products to be satisfied. On the other hand, apparatuses according to the disclosure meet the demand for increasingly smaller available storage areas for such packaging product preparation apparatus. For example, the rule of thumb for the overall dimensions of apparatus according to the disclosure is that they must not exceed the outer dimensions of a standard industrial pallet. For example, apparatus according to the disclosure have an overall dimension of less than 650 mm in length in the conveying device, less than 450 mm in width transversely to the conveying device and less than 300 mm in height transversely to the conveying and width direction. The apparatus according to the disclosure can be arranged to produce small or miniature packaging products or cushions. Such small or miniature packaging products may have a length in the conveying device of less than 30 mm, a width of less than 120 mm, in particular in the portion of 80 to 90 mm, and a height of less than 40 mm, in particular in the portion of 20 to 30 mm.

The apparatus may comprise a preforming station adapted to form the raw material by radially inwardly folding lateral raw material web sections of the raw material two lateral crumple cavities extending in the web direction and a central overlap zone extending in the web direction, in which the raw material web sections folded around overlap. The raw material can be deformed into a three-dimensional intermediate product with at least one crumple cavity extending in the web direction. In an exemplary embodiment of the apparatus, the shape of the intermediate product can essentially correspond to that of the final packaging product. The intermediate product is then used to produce the packaging product. In an exemplary embodiment, the preforming station may comprise a funnel-like turn-in or rolling-in device, such as a convergence funnel, which turns-in or rolls-in the paper web laterally in the transverse direction as it is conveyed into the apparatus, so that the longitudinal edges of the paper web, which are provided for example by means of a leporello stack source, are essentially turned-in one above the other in the center of the paper web.

The preforming station can have a take-off device for drawing in and conveying the raw material. The take-off device can have a pair of continuous conveyors, such as conveying wheels or conveying rollers, located opposite each other. For example, the conveying wheels or conveying rollers can be pre-tensioned against each other, in particular spring pretensioned, so that a pretensioning force, in particular an elastic one, is exerted on the raw material web. The continuous conveyors can basically be characterized by a continuous conveying movement. The continuous conveyors convey the raw material in the conveying direction, in particular in the direction of a discharge opening at which the packaging products can be removed or discharged or ejected, in particular with frictional engagement. The continuous conveyors delimit a conveyor channel between them, through which the raw material is transported. As a rule, the continuous conveyors delimit the conveyor channel at least partially in the vertical direction upwards and downwards. Lateral channel limiting elements may also be provided.

Furthermore, the apparatus can comprise a deformation station adjoining the preforming station in the conveying device of the raw material, which can be formed by a pair of embossing and/or deformation wheels adapted to bind overlapping material web sections to one another along a fastening and/or deformation zone extending in the web direction and to convey the preformed raw material. The embossing and/or deformation wheels interlock in the fastening and/or deformation zone in order to deform the wrapped or rolled-up raw material web into the cushioning product. This creates the central fastening and/or deformation zone in the raw material. This specific cushioning product may comprise a substantially central deformation zone extending in the longitudinal direction, in particular an embossing and/or perforation zone, which is adjoined in the transverse direction by two lateral cavity crumple zones, the lateral end of which also forms the end of the cushioning product. In this respect, the apparatus can produce a paper cushioning product that is essentially dumbbell-shaped in cross-section.

The apparatus further may comprise a separating station following the preforming station in the conveying direction of the raw material, which separates a packaging product of a desired length from the raw material.

According to one aspect of the present disclosure, a cutter of the separating station is guided in such a way that, in cutting engagement, it cuts through the raw material web transversely to the conveying direction against the gravitational direction or transversely to the gravitational direction in a translatory manner. For the purposes of the present application, cutting through is to be understood in particular to mean that the raw material web is cut through continuously or sectionally along at least 20% of its width running transversely to the web direction, wherein the cutting through can be realized by partially cutting through, partially penetrating, perforating, (partially) piercing and/or scoring and generally by weakening the raw material web. This means that when cutting through the raw material web, the cutter does not necessarily have to penetrate completely through the material web thickness, but can, for example, only penetrate the material web thickness to a certain extent. Cutting engagement is understood to mean in particular the point in time at which the cutter plunges into the raw material web. In cutting engagement, the cutter can plunge into the raw material web over its entire depth, i.e. its longitudinal extent transversely to the conveying direction. In other words, the cutter can run in a straight line in this depth direction, which is orientated parallel to the width of the raw material web. Due to the translational penetration of the raw material web in the cutting engagement transversely to the conveying direction, the raw material web is in particular subjected to a cutting force transversely to the conveying direction. In particular, this cutting force can cause the raw material web to be tensioned in the conveying direction before the actual cutting. For example, the cutter can be guided in such a way that it travels through the raw material web in translation. Cutting the raw material web against the direction of gravity has proven to be advantageous in that the weight of the raw material web to be cut is thus orientated against the translational cutting direction. Furthermore, it is thus possible to design the apparatus in a modular and/or very compact manner. The fact that the direction of translational movement is orientated from bottom to top, i.e. against the direction of gravity, means that all drive, motor and gear components can be arranged at the bottom of the apparatus, in particular below a conveying path leading through the apparatus, along which the raw material web is conveyed. This ensures that free access to all components processing the raw material web is possible from above, in particular without stationary operating, gear or motor components being in the way. These are then accessible from below in a compact and, if necessary, spatially organized manner. The cutter works like a guillotine. The cutting movement direction transversely to the conveying direction can also be orientated transversely to the planar extension of the raw material web, which is defined by the conveying direction and a width direction of the raw material web orientated transversely to the conveying direction. The direction of cutting movement transversely to the direction of gravity can be a lateral cut, for example from left to right or vice versa.

In an exemplary embodiment of the apparatus according to the disclosure, the apparatus has a motor for providing a driving force and a gear for transmitting the driving force to the separating station. The motor-driven separating station has therefore been shown to be advantageous, since the apparatus as a whole can be mechanized without the need for intervention by an operator. In addition, the cutting of individual packaging products can be controlled, in particular the length of the packaging products to be produced can be adjusted, and furthermore the cutting to length or cutting off of the packaging products to be produced can be adapted to the operation of the apparatus according to the disclosure. Furthermore, the gear and the motor are arranged below a vertical height determined by the cutting engagement. Furthermore, the motor and gear can be arranged below the conveying path running through the apparatus, along which the raw material web and finally the packaging product are guided through the apparatus. In an alternative embodiment, the gear and the motor can also be arranged above the vertical height determined by the cutting engagement.

According to an aspect of the present disclosure, which can be combined with the preceding aspects and exemplary embodiments, there is provided an apparatus for producing a three-dimensional packaging product from a web-shaped raw material, comprising a preforming station adapted to forming two lateral crumple cavities extending in the web direction and a central fastening and/or deformation zone extending in the web direction, in which the folded-over raw material web sections overlap and are bonded to one another, by radially inwardly folding lateral raw material web sections of the raw material, and a separating station adjoining the preforming station in the conveying direction, which separates a packaging product of a desired length from the raw material. With regard to the features of the generic term, reference can be made to the preceding embodiments in order to avoid repetition.

According to the further aspect according to the disclosure, the separating station has a cutter which is designed and/or mounted in such a way that, in the course of a separating process, a cut through the raw material web propagates transversely to the conveying direction, in particular transversely to the planar extension of the raw material web, in the width direction of the raw material web. In this case, a cutting engagement point, which is characterized by the contact of the cutter with the raw material web, can move transversely to the conveying direction in the width direction of the raw material web during the cutting process. For example, the cutting process begins at a lateral edge of the raw material web and spreads in the direction of and up to the opposite edge of the raw material web. This results in a zip-like opening or separation of the raw material web. It has been found that this type of cutting movement and cut propagation improves the quality of the cut on the raw material web. In particular, the tendency towards small micro tears in the conveying direction and/or fraying is reduced, wherein at the same time undesired deformation of the sections of the raw material web that are separated from each other in the conveying direction is prevented.

In an exemplary embodiment of the apparatus according to the disclosure, the cutter translationally cuts through the raw material web in cutting engagement transversely to the conveying direction, in particular transversely to the planar extension of the raw material web. Due to the translatory penetration of the raw material web in the cutting engagement transversely to the conveying direction, the raw material web is in particular subjected to a cutting force transversely to the conveying direction. In particular, this cutting force can cause the raw material web to be tensioned in the conveying direction before the actual cutting. For example, the cutter can be guided in such a way that it travels through the raw material web in translation.

According to an aspect of the present disclosure, which can be combined with the preceding aspects and exemplary embodiments, there is provided an apparatus for producing a three-dimensional packaging product from a web-shaped raw material, which may comprise a forming station adapted for this purpose, forming two lateral crumple cavities extending in the web direction and a central fastening and/or deformation zone extending in the web direction, in which the folded-over raw material web sections overlap and are bonded to one another, by radially inwardly folding lateral raw material web sections of the raw material, and a separating station which adjoins the preforming station in the conveying direction and separates a packaging product of a desired length from the raw material. With regard to the features of the generic term, reference is made to the preceding embodiments in order to avoid repetition.

According to an aspect of the disclosure, the separating station may comprise a cutter and a counter cutter along which the cutter shears in the course of a separating process. The shear cut arrangement has proven to be advantageous and efficient with regard to the cutting or separation result. The co-operating cutters are particularly suitable for high cutting speeds and a machine apparatus or machine separating processes.

According to an aspect of the disclosure, the apparatus may comprise an adjusting device for positioning the counter cutter and cutter relative to one another. In this way, the alignment required for the shear cut can be adjusted to optimize the shearing of the cutter and counter cutter against each other. Furthermore, the positioning of the cutter and counter cutter relative to each other can be readjusted as wear increases. Furthermore, the adjusting device makes it possible to position the cutter and the counter cutter relative to each other in such a way that the cutter is pre-tensioned against the counter cutter during cutting engagement, i.e. when the cutters are cut to length, against the conveying direction of the raw material. This ensures reliable embodiment of the cutting process.

According to an exemplary embodiment of the present disclosure, the cutter shears along the counter cutter, in particular translationally, in a cutting plane which is orientated transversely to the conveying direction, in particular transversely to the planar extension of the raw material web. In an exemplary embodiment, the cutting plane is orientated in such a way that the vertical direction, which lies in the cutting plane, and the translational cutting movement direction are orientated in the opposite direction to the gravitational direction.

According to an exemplary embodiment of the present disclosure, the cutter shears along the counter cutter, in particular translationally, in a cutting plane and is pre-tensioned transversely to the cutting plane, in particular against the conveying direction, against the counter cutter. The pre-tensioning of the cutter and counter cutter produces a better cutting result and a clean separation of the packaging product.

In an exemplary embodiment of the apparatus according to the disclosure, the apparatus may comprise a counter cutter along which the cutter shears in the course of a separation process. The counter cutter is held by a counter cutter carrier, which is arranged in particular in a fixed position on the apparatus. Furthermore, the counter cutter carrier delimits a conveying path of the raw material web through the apparatus transversely to the conveying direction of the raw material web. In this respect, the counter cutter carrier can form a path limiting element, in particular in the vertical direction. In this respect, the counter cutter carrier serves not only to support the counter cutter, but also to delimit the conveying path and thus to reduce the risk of paper jams.

According to an exemplary embodiment of the present disclosure, the apparatus may comprise a counter cutter along which the cutter shears in the course of a separation process. The counter cutter is movably mounted on a counter cutter carrier, in particular a stationary counter cutter carrier, in the conveying direction. The movable mounting of the counter cutter on the counter cutter carrier can be created by means of the adjusting device. The pre-tensioning of the cutter and counter cutter can be adjusted via the adjusting device and the movable mounting of the counter cutter and counter cutter carrier. The adjusting device can, for example, include grub screws for displacing the counter cutter, in particular horizontally, relative to the counter cutter carrier.

According to an exemplary embodiment with the apparatus according to the disclosure, the cutter is firmly held by a cutter carrier which is guided in translation, in particular relative to the counter cutter carrier, which is in particular stationary. The cutter carrier and possibly the guide can be designed in particular in such a way that during a separation process the cutter moves essentially exclusively along the cutting plane, wherein evasive movements in or against the conveying direction are essentially excluded. The translational guide of the cutter carrier, in particular orientated in the vertical direction, can be designed using suitable linear guides, such as a straight guide, a rail guide, a guide link or the like.

According to an exemplary embodiment of the apparatus according to the disclosure, the cutter and/or the counter cutter is made of a material whose working hardness is at least 10 HRC and/or at most 85 HRC, in particular in the portion of 40 to 70 HRC. For example, the degree of elongation at break is in the portion of at least 0.1% and/or at most 25%, in particular in the portion of 0.5% to 15%. For example, the cutter and/or the counter cutter is made of steel, such as a cold work steel, a stainless steel or a tool steel. For example, the material with the number 1.2436 can be used as a cold work steel. A stainless steel can be used by the material with the number 1.4112, the material with the number 1.3343 is suitable as a tool steel.

In an exemplary embodiment of the apparatus according to the disclosure, the cutter has a cutting edge which is inclined at an angle in the portion of 93° to 105°, in particular 98°, relative to the direction of cutting movement. In other words, the cutting edge is inclined at an angle in the portion of 3° to 15°, in particular 8°, relative to the horizontal. In this way, the cutter only dips into the raw material web at certain points during cutting engagement, so that during a separation process a cut through the raw material web is propagated transversely to the conveying direction in the width direction of the raw material web. The cutting engagement point moves transversely to the conveying direction in the width direction of the raw material web.

According to an exemplary embodiment, the apparatus may comprise a counter cutter along which the cutter shears in the course of another process. The counter cutter has a shearing surface which is orientated, for example, in the conveying direction and which is inclined at an angle in the portion of 1° to 10°, in particular 5°, relative to the direction of cutting movement. The inclination of the shearing surface is orientated in such a way that a lower shearing edge facing the cutter protrudes furthest in the conveying direction in relation to the shearing surface. This allows the cutter to shear mainly along the shearing edge during the side-by-side shearing process, which improves the cutting quality and the effectiveness of the separation process. This also reduces wear on the cutting elements.

According to an exemplary embodiment, the apparatus according to the disclosure may comprise a motor for driving the separating station. This essentially eliminates the need for intervention or operation by an operator. Furthermore, the apparatus according to the disclosure is perfectly suited in this way for an automated packaging production operation, in particular in mass production.

As described in more detail at the beginning, the apparatus according to the disclosure is arranged to produce particularly small packaging products. Irrespective of this, the apparatus has a particularly compact design. An inventive idea is now to adapt individual components and structural units of the apparatus for producing miniature packaging products to the available raw material, so that the raw material is arranged to be processed both by the large machines and by the inventive apparatus. This reduces the manufacturing costs and the number of variants of the raw material, as only one paper quality is involved.

As described at the beginning, one aspect of the disclosure is a modular design of the apparatus. One of these modules forms the separating station. A first solution for a separating station is that it may comprise at least the stationary mechanical elements such as the counter cutter carrier, the counter cutter and its adjusting device and, in one embodiment, the guide rods for guiding the cutter carrier. It also consists of the elements that are movable relative to the counter cutter, such as the cutter carrier and the cutter. A separating station of this type is formed as a functional unit so that it can be pre-assembled and functionally tested independently of the apparatus. A further solution for the separating station module may also include a motor with a downstream gear and a crank rod, wherein the drive shaft of the gear is connected to the movable cutter carrier via the crank rod. Furthermore, the gear and/or the motor are operatively connected to the counter cutter carrier. In one embodiment, this module can also be formed as a self-sufficient and intrinsically functional module.

In another alternative design of the separating station, the gear for driving the cutter in a movable manner is arranged below the conveying path. Since the motor is directly connected to the gear, the motor is also arranged below the conveying path, but at least in sections. An at least sectionally arrangement of the motor below the conveying path is particularly the case if the motor of the separating station extends essentially upright in accordance with another compact design of the apparatus. Since the separating station motor is designed as an elongated structure along its central longitudinal axis, it is then arranged at least sectionally next to the conveying path. With the upright extension of the motor, its central longitudinal axis as well as the motor shaft are in a vertical upward direction or alternatively in another oblique upward direction. According to an aspect of the present disclosure, which can be combined with the preceding aspects and exemplary embodiments, there is provided a packaging product, in particular a paper packaging product, which is produced from a web-shaped raw material by means of an apparatus formed according to one or more of the aspects and/or embodiments, and/or whose width measured transversely to the longitudinal web direction is less than 12 cm and/or whose length in the longitudinal web direction is less than 30 cm. It has been found in the prior art that there is a great need for miniature packaging products, which can be satisfied by the packaging products according to the disclosure.

According to an aspect of the present disclosure, which can be combined with the preceding aspects and exemplary embodiments, a system is provided with an apparatus designed in accordance with one of the aspects described above or one of the exemplary embodiments described above for producing a three-dimensional packaging product from a web-shaped raw material and a raw material supply arranged in particular in the conveying direction upwards of the apparatus. The raw material supply can be in the form of a raw material web roll, in particular in the form of a coreless roll, or a leporello-stack. For example, a web-shaped raw material extends from the raw material web supply into the apparatus, in particular into its preforming station.

In the following description of exemplary embodiments of the present disclosure, an apparatus according to the disclosure for producing a three-dimensional packaging product from a web-shaped raw material, in particular paper raw material, is generally provided with the reference numeral 1. For the description of the following embodiments with reference to the accompanying figures, it should be assumed that the overall dimensions of the illustrated apparatus 1 are such that the apparatus 1 can be placed on a standard industrial pallet and does not exceed its dimensions. For example, the overall length of the apparatus is less than 650 mm, the overall width is less than 450 mm and the overall height is less than 300 mm. The apparatus 1 of the embodiments illustrated in the figures is adapted to produce small or so-called miniature packaging pads whose length in the web direction of the raw material is less than 120 mm, in particular in the portion of 80 mm to 90 mm, whose width measured transversely to the longitudinal direction is less than 120 mm, in particular in the portion of 80 mm to 90 mm, and whose height is less than 40 mm, in particular in the portion of 20 mm to 30 mm.

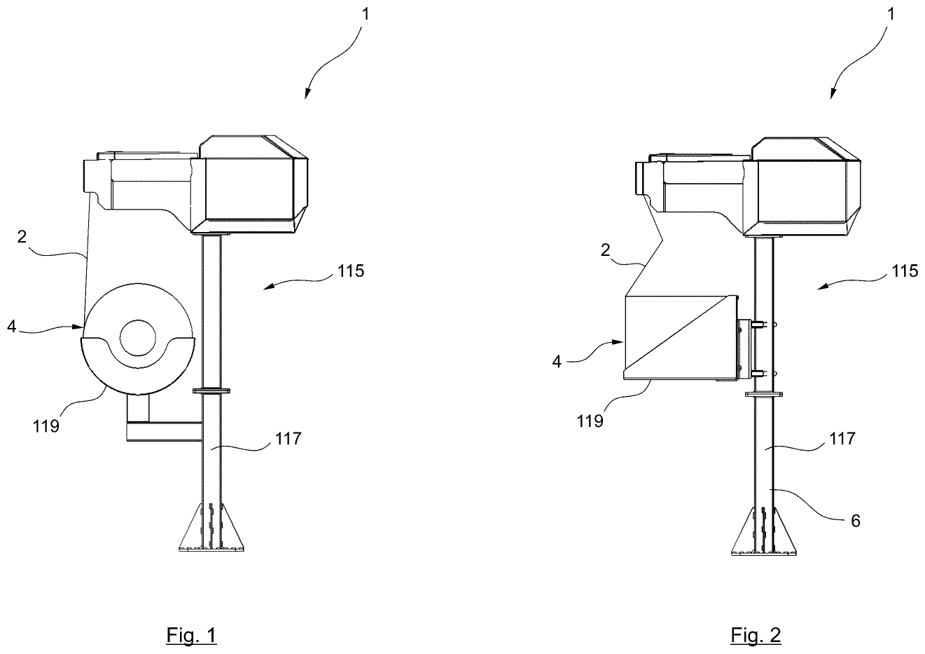

FIGS. 1 and 2 show schematic principle sketches of exemplary embodiments of apparatus 1 according to the disclosure, which have an integrated raw material supply 4, which may, for example, be in the form of a leporello-stack (FIG. 2) or in the form of a raw material roll, in particular in the form of a coreless roll (FIG. 1). The apparatus 1 can also be provided with a stator 6, with which the apparatus 1 can be placed on the base and with respect to which the apparatus 1 can be adjusted in its orientation and on which the height of the apparatus 1 can be adjusted.

The apparatus 1 according to the disclosure is further part of an exemplary embodiment of a system according to the disclosure, which is generally provided with the reference numeral 115 and further may comprise the raw material supply 4. According to the embodiment shown in FIGS. 1 and 2, the system 115 also may comprise a frame 117 on which the apparatus is fixedly, possibly detachably and/or pivotably, mounted, which may comprise the stator 6, for placing the apparatus 1 on a surface. Furthermore, a receptacle 119 for the raw material supply 4 is arranged on the frame 117, which is formed according to the type of raw material supply 4.

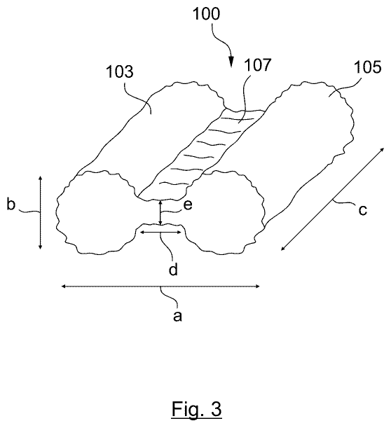

FIG. 3 shows a schematic representation of a packaging product 100 according to the disclosure, which is produced from a web-shaped raw material 2 by means of an apparatus 1 according to the disclosure and/or whose width a, measured transversely to the longitudinal web direction, is less than 12 cm, whose length c in the longitudinal direction of the web is less than 30 cm, whose vertical extension b is in the portion of 2 cm to 3 cm. The packaging products 100 according to the disclosure comprise two lateral crumple cavities 103, 105 extending in the longitudinal web direction, which are formed by radially inwardly folding or inwardly rolling-in lateral raw material web sections of the raw material. Furthermore, the packaging product 100 according to the disclosure may comprise a central fastening and/or deformation zone 107 in which the folded-over raw material web sections overlap and are bound together. A width d of the fastening and/or deformation zone, measured in the width direction, can be in the portion of 2 cm to 2.5 cm, the vertical extension e of which is below 1.5 cm or below 1 cm.

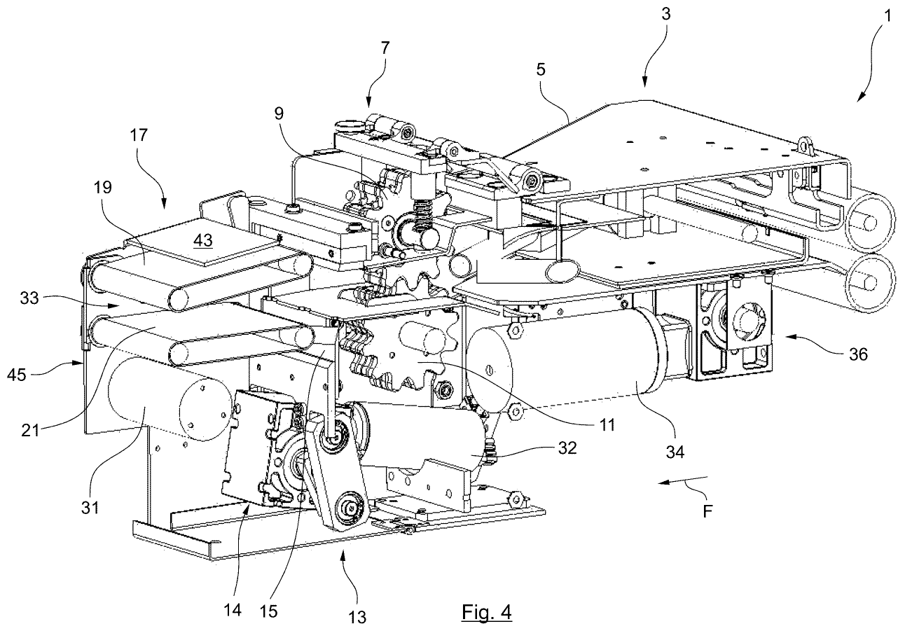

An apparatus 1 according to the disclosure (FIG. 4) can be divided into the following main components in the conveying direction, which is indicated by the arrow with the reference sign Fin FIG. 4:
a preforming station 3 for deforming the web-shaped raw material into a three-dimensional intermediate product with at least one crumple cavity 103, 105 extending in the web direction, which has a funnel-like turn-in or rolling-in device 5;
an embossing and/or perforating station 7 adjoining the preforming station 3 in the conveying direction F and having a pair of intermeshing embossing and/or perforating wheels 9, 11 which are adapted to bind together overlapping raw material web sections along a fastening and/or deformation zone 107 extending in the web direction;
a separating station 13 adjoining the embossing and/or perforating station 7 in conveying direction F with a translationally guided cutter 15 for separating a packaging product 100 of a desired length from the raw material web 2; and
an output device 17 adjoining the separating station 13 in conveying direction F and having a pair of opposing continuous conveyors 19, 21 for discharging the separated packaging product 100.

FIG. 4 shows that all drive, motor and gear components are arranged below the conveying path through the apparatus 1, which is indicated by the dashed line with the reference sign P.

Viewed in the opposite conveying direction F, the apparatus 1 has a motor 31 for the output device 17, a motor 32 for the separating station 13 and a common motor 34 for the embossing and/or perforating station 7 and the take-off device 36. In the portion of the output device 17, an output device housing 43 can also be seen, which is part of an overall housing 45 of the apparatus. The housing 45 or the output device housing 43 basically serves to prevent undesired access by an operator to the interior of the apparatus 1 in order to avoid injuries, as well as for delimiting the conveying path or the discharge channel 33 and for attaching components of the apparatus 1.

Referring again to FIG. 4, the apparatus 1 has a gear 14 associated with the separating station 13 in the form of a coupling gear for converting the torque generated by the drive motor 32 into a translational cutting movement of the cutter 15 of the separating station 13. The up and down movement of the guillotine cutting edge 15 is orientated in such a way that a cutting movement is directed against the direction of gravity, i.e. from bottom to top in the figure.

The drive motor 34 for the embossing and/or perforating station 7 and for the take-off device 36 is directed in the opposite direction to the conveying direction F, so that a drive shaft of the drive motor 34 extends from the motor 34 in the opposite direction to the conveying direction F.

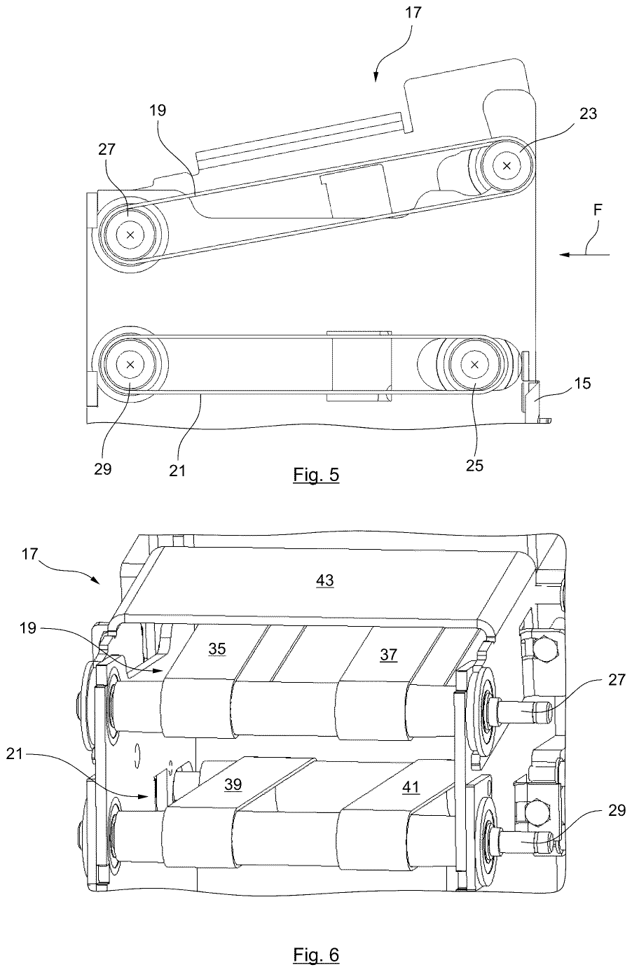

In the embodiment of the output device 17 in FIG. 5, the upper continuous conveyor 19 protrudes against the conveying direction F at the upstream end over the lower continuous conveyor 21 and extends against the conveying direction F as far as the cutter 15 of the separating station 13. In the exemplary embodiments, the two continuous conveyors 19, 21 are each realized as conveyor belts which are each guided around an upstream reversing roller 23, 25 and around a downstream reversing roller 27, 29. For example, the downstream reversing rollers 27, 29 form the drive shafts for the conveyor belts 19, 21 and are coupled to an output device motor 31 via a gear, for example a belt or a chain, in a power transmission manner. The axes of rotation of the downstream reversing rollers or drive shafts 27, 29 are at the same height in relation to the conveying direction F. The axes of rotation of the upstream reversing rollers 23, 25, which are in particular not driven but free-running, are offset with respect to the conveying direction F, namely in particular in such a way that the axis of rotation of the upper reversing roller 23 is arranged upstream with respect to the axis of rotation of the lower reversing roller 25, counter to the conveying direction F. This offset, as indicated in detail in the above description, has the effect of reducing the risk of paper jamming within the apparatus 1.

In the embodiment of the output device 17 illustrated in FIG. 6, the special feature is that the continuous conveyors 19, 21 formed as conveyor belts, unlike in the embodiment according to FIG. 5, in which the conveyor belts 19, 21 are each formed from one piece and extend essentially over the complete width of a discharge channel 33 delimited by the conveyor belts 19, 21, consist of two equally dimensioned conveyor sections 35, 37 or 39, 41 arranged transversely to the conveying direction F at a distance from one another. The distance between two conveyor sections 35, 37 or 39, 41 of the same pair is matched to a width of the packaging products measured transversely to the conveying direction F. In particular, the distance is determined such that the conveyor sections 35 to 41 in this case come into conveying contact exclusively with the two lateral, voluminous crumple cavities 103, 105 of the packaging product 100, without any engagement with the central deformation and/or fastening zone 107. For example, the position of the conveyor sections 35 to 41 can be adjustable with respect to the width direction on the respective shafts 27, 29 in order to provide an adjustment option with respect to differently dimensioned packaging products 100.

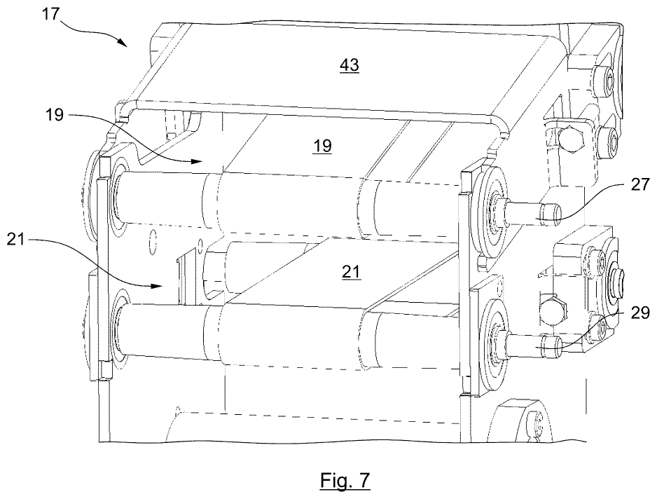

The embodiment of the output device 17 of FIG. 7 differs from that of FIG. 6 with regard to the design of the conveyor belts forming the continuous conveyors 19, 21. According to FIG. 7, these are arranged in the center with respect to the width extension of the drive shafts 27, 29 bearing and driving them, so that these are intended to be able to make conveying contact with the central fastening and/or deformation zone 107. In this case, a width extension of the conveyor belts 19, 21 is matched to a width extension of the fastening and/or deformation zone 107.

FIGS. 6 and 7 also show an output device housing 43, which is part of an overall housing 45 of the apparatus. The housing 45 or the output device housing 43 basically serves to prevent undesired access by an operator to the interior of the apparatus 1 in order to avoid injuries, as well as for delimiting the conveying path or the discharge channel 33 and for attaching components of the apparatus 1, as well as for supporting the drive shafts 27, 29.

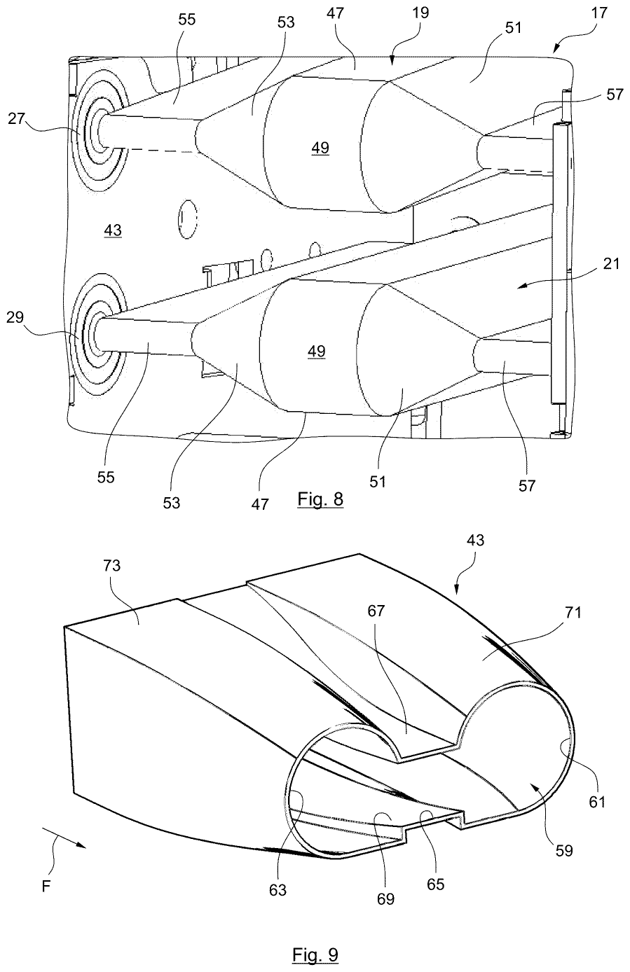

FIG. 8 shows an exemplary embodiment of the output device 17, which differs from the preceding embodiments in that the continuous conveyors 19, 21, which are realized as conveyor belts, are shaped complementary to the dumbbell-shaped outer contour of the packaging products 100 according to the disclosure. With this design of the continuous conveyors 19, 21, the greatest possible conveying contact between the continuous conveyors 19, 21 and the packaging product 100 can be realized. The continuous conveyors 19, 21 comprise a fastening and/or deformation zone conveyor section 47 which is centered in relation to the width direction and consists of a centered, fully cylindrical section 49 and two conical or frustoconical sections 51, 53 each adjoining one side. The fastening and/or deformation zone conveyor section 47 opens on both sides into a respective straight crumple cavity conveyor section 55, 57. The central fastening and/or deformation zone conveyor section 47 is shaped to engage between the two lateral crumple cavities 103, 105 in the fastening and/or deformation zone 107 of the packaging product 100. The two adjoining lateral crumple cavity conveyor sections 55, 57 serve to make conveyor contact with the crumple cavities 103, 105 so that the packaging product 100 can be gripped and conveyed over as large an area as possible.

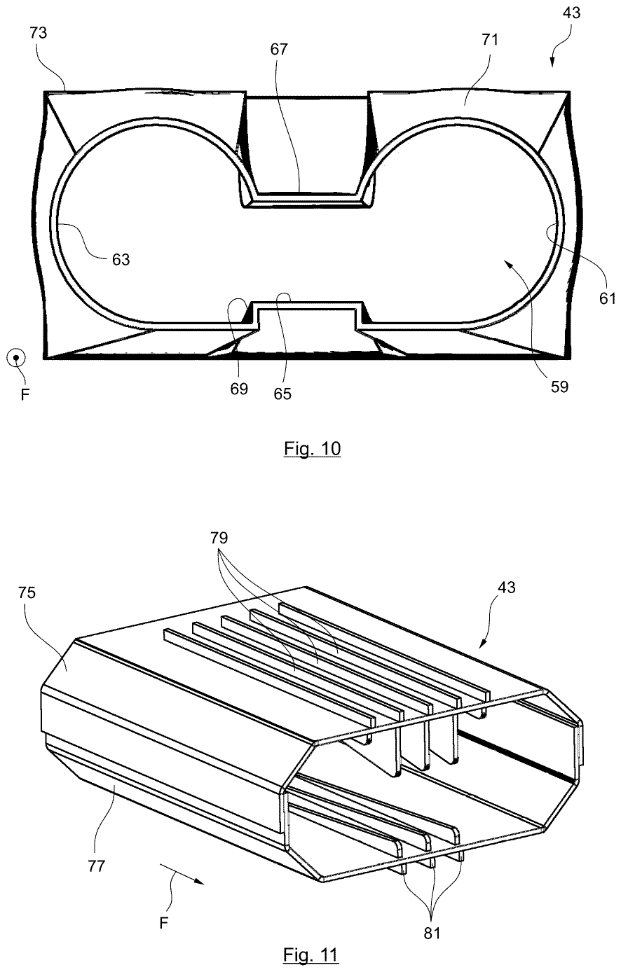

FIGS. 9 and 10 show an exemplary embodiment of a section of the output device housing 43 in perspective side view and in top view. Referring to the preceding embodiments, in which the continuous conveyors 19, 21 are partially adapted in shape to the outer contour of the packaging product 100, the output device housing 43 according to FIGS. 9 and 10 is shaped such that it replicates the outer contour of the packaging product 100. Basically, the output device housing 43 tapers in the conveying direction F and ends in a delivery opening 59, the opening cross-section of which is shaped according to the outer contour of the packaging products 100. The delivery opening 59 has two lateral crumple cavity passages 61, 63, which are substantially rounded in shape and are shaped to match the shape of the lateral crumple cavities 103, 105 of the packaging products 100. Furthermore, the delivery opening 59 has a central fastening and/or deformation zone passage 65 connecting the crumple cavity passages 61, 63, which is formed by two housing wall sections 67, 69 extending or projecting into the conveying path. The lateral crumple cavity passages 61, 63 are adjoined by crumple cavity channels 71, 73, which in turn basically reflect the outer contour of the crumple cavities 103, 105, but which approach an overall rectangular structure of the output device housing 43 in the opposite direction to the conveying direction F.

The output device housing 43 shown in FIGS. 11 and 12 follows the same principle of replicating the outer contour of the packaging product 100, but is realized with a different construction. The output device housing 43 consists of two interconnected housing halves 75, 77, which basically delimit a constant conveying cross-section as viewed in the conveying direction F. In the center with respect to the width of the output device housing 43, housing boot bars 79, 81 are arranged in the two housing shells 75, 77, which extend into the conveying path and are arranged and/or dimensioned in such a way that they are essentially formed for engaging and guiding the fastening and/or deformation zone 107 of the packaging products 100, while laterally leaving a free space with a larger cross-section free for the lateral crumple cavities 103, 105. The plurality of housing webs 79, 81 can decrease at least in the portion of the upper housing half 75 with respect to its extension into the conveying path in the direction of the lateral housing boundary in order to reproduce the outer contour of the packaging products 100 as faithfully as possible.

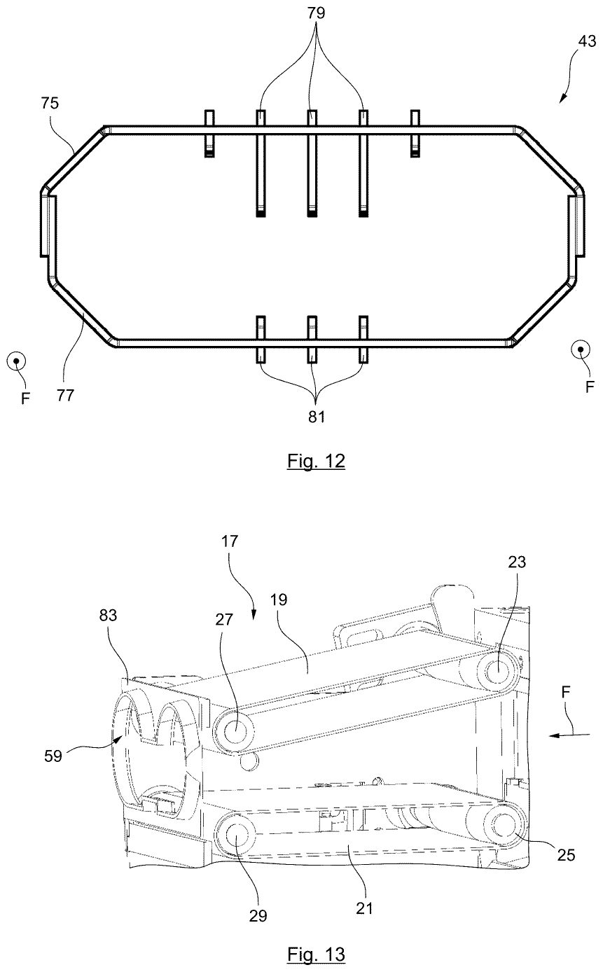

FIG. 13 shows an embodiment of the output device 17 in which the rectilinear continuous conveyors 19, 21, for example from FIG. 4, are combined with a housing part 83 on the delivery opening side, which has a delivery opening 59 shaped in accordance with the embodiment from FIGS. 9 and 10.

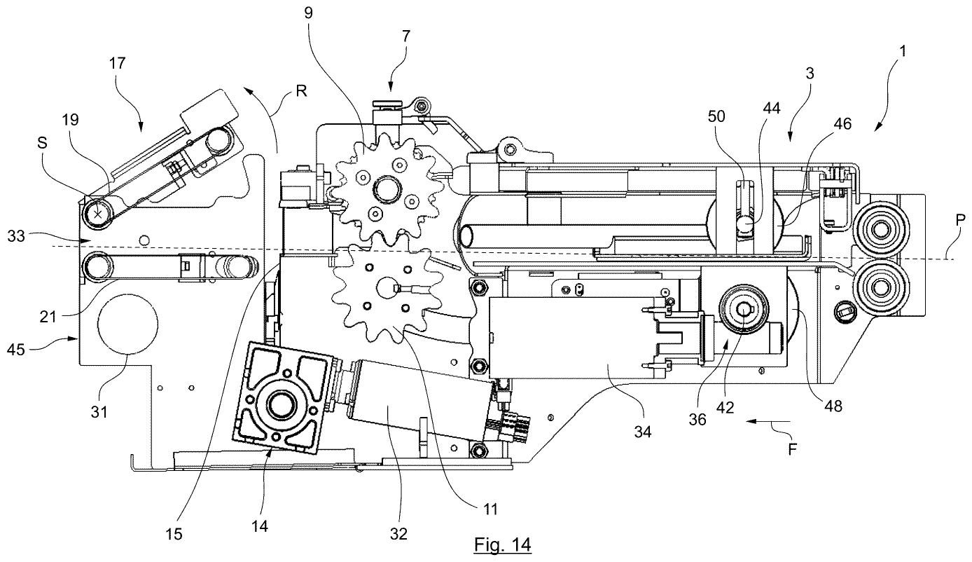

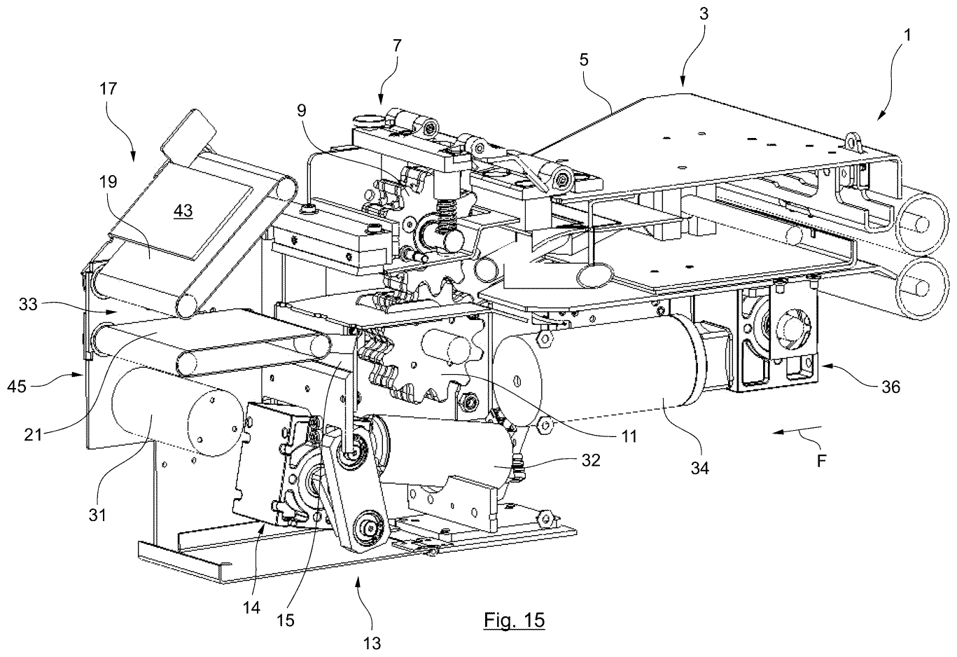

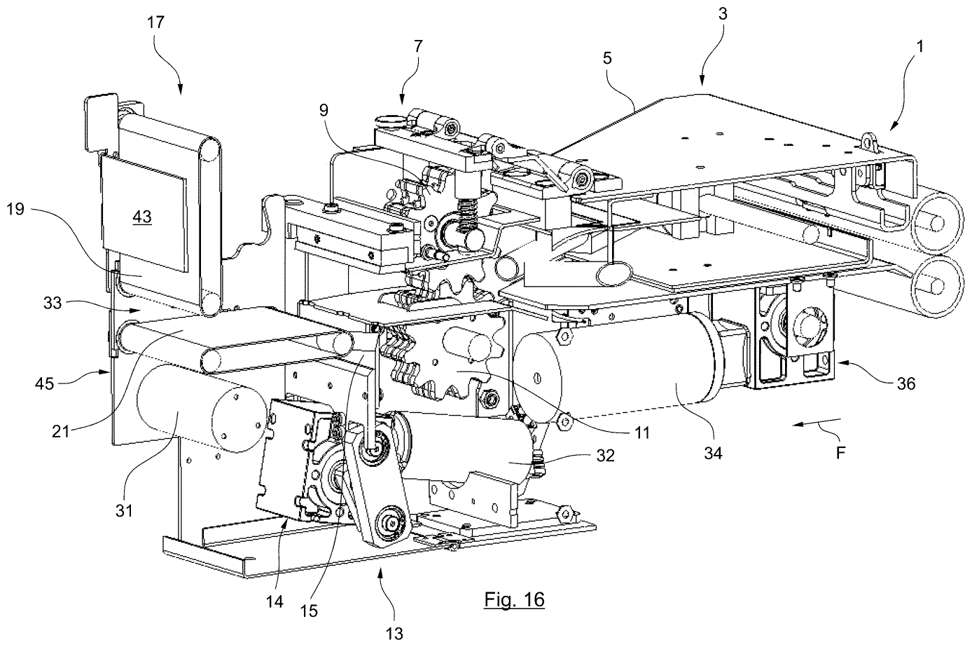

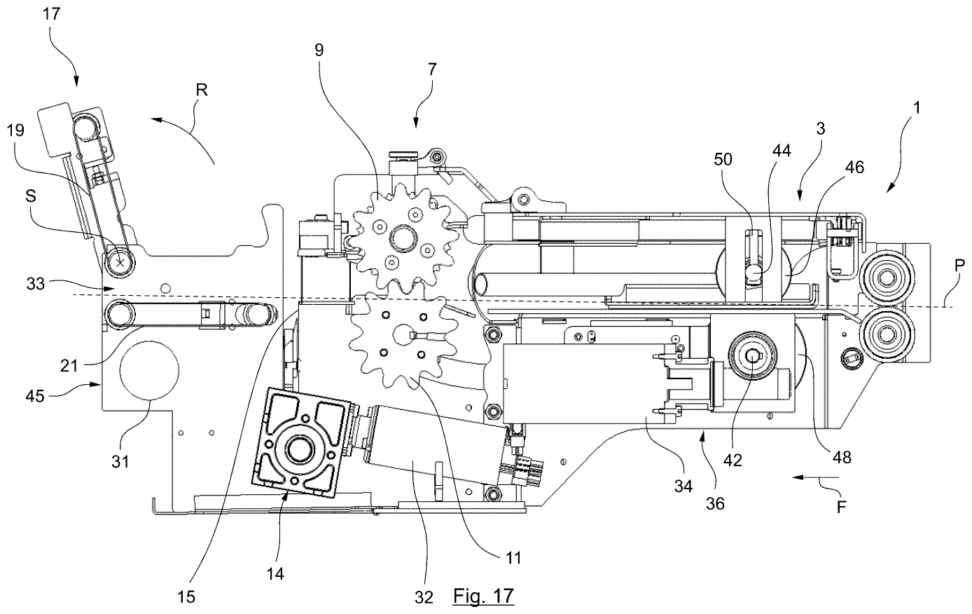

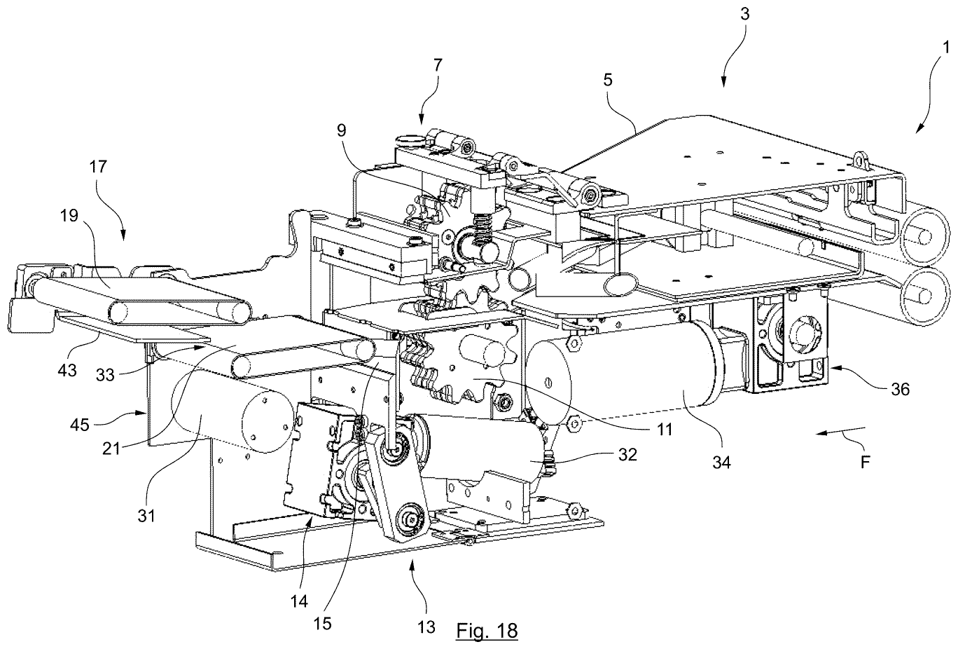

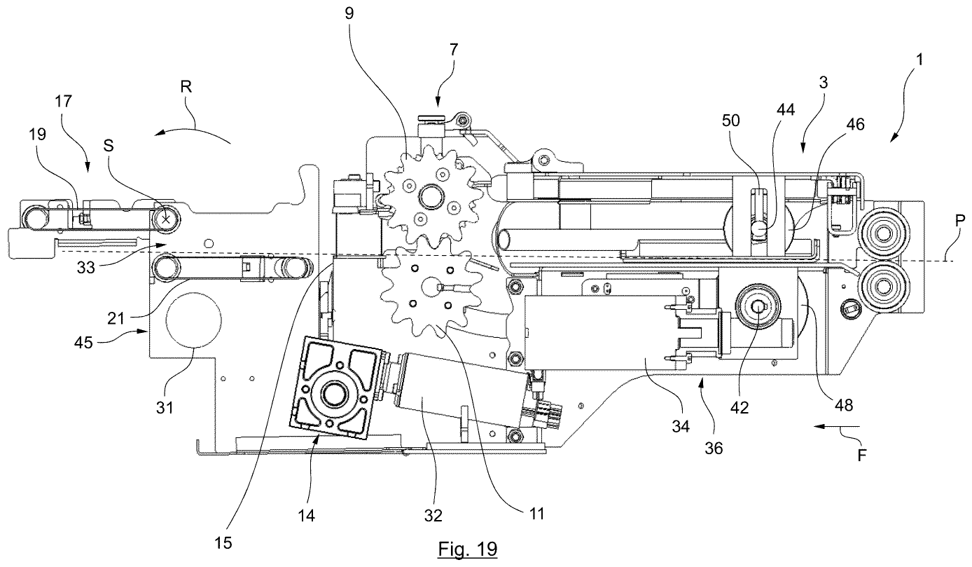

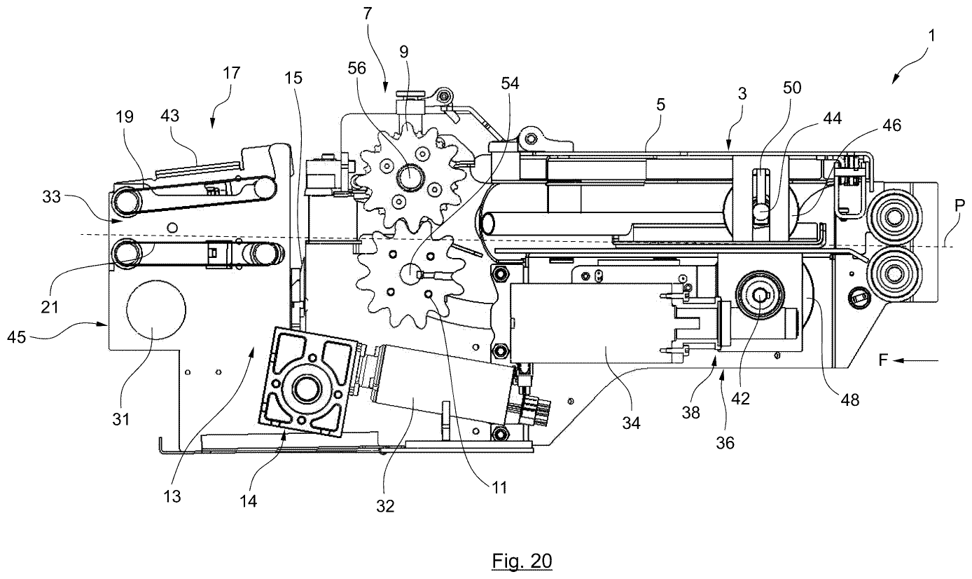

FIGS. 14 to 19 illustrate an exemplary embodiment of an apparatus 1 according to the disclosure, according to which the upper continuous conveyor 19 is mounted so as to be movable, namely pivotable, relative to the lower continuous conveyor 21. With reference to FIG. 4, an operating position of the two continuous conveyors 19, 21 during the production of packaging products 100 according to the disclosure is shown. FIGS. 14 to 19 show stepwise exemplary intermediate positions between the operating position shown in FIG. 4 and a passive position of the upper continuous conveyor 19 shown in FIG. 19. The passive position can be, for example, a maintenance position in which maintenance measures, in particular of all components of the output device 17, can be carried out, a repair position or a paper jam removal position. In any case, access between the continuous conveyors 19, 21 is achieved or created by swiveling the upper continuous conveyor 19 away from the lower continuous conveyor 21, e.g. in order to remove a material jam that has formed there.

In the position of the upper continuous conveyor 19 shown in FIG. 14, it is already swiveled open with respect to a pivot axis S coinciding with the axis of rotation of the upper drive shaft 27 in a swiveling direction, which is indicated by the arrow with the reference sign R, so that a larger access area is already created at the upstream end of the delivery device 17 compared to the operating position in FIG. 4. As can be seen in particular from the sequence of FIGS. 14 to 19, the upper continuous conveyor 19 is increasingly swiveled open about the pivot axis S in the conveying direction F until finally the upper continuous conveyor is swiveled well beyond the 90° position with respect to the lower continuous conveyor 21 and can even assume a parallel position with respect to the lower continuous conveyor 21 (FIG. 19). In this way, on the one hand, the largest possible access area to the interior of the output device is made possible. On the other hand, the swiveling direction R in the direction of the conveying direction F ensures that the upper continuous conveyor 19 and the components of the output device 17 firmly coupled thereto do not collide with other components or parts of the apparatus 1 according to the disclosure. To resume the operating position shown in FIG. 4, the upper continuous conveyor 19 is swiveled back again in the opposite direction to the swiveling direction R in relation to the pivot axis S.

Viewed in the opposite direction to conveying direction F, the apparatus 1 has a motor 31 for the output device 17, a motor 32 for the separating station 13 and a common motor 34 for the embossing and/or perforating station 7 and the take-off device 36. The drive motor 34 for the embossing and/or perforating station 7 and for the take-off device 36 is directed in the opposite direction to conveying direction F, so that a drive shaft of the drive motor 34 extends from the motor 34 in the opposite direction to conveying direction F. The output shaft of the drive motor 34 can transmit the driving force to a drive shaft of the take-off device 36 via a meshing engagement, for example a bevel gear toothing or a worm gear toothing. As can be seen in particular in FIG. 14, the take-off device 36 has two take-off or conveying wheels 46, 48, each mounted on a shaft 42, 44, with which the raw material is drawn into the apparatus 1 and conveyed through it. FIG. 14 also shows that the upper conveying wheel 46 is movably mounted in the material thickness direction, i.e. perpendicular to the planar extension of the raw material within the apparatus 1, which is indicated by a rail guide 50 in FIG. 14. Furthermore, the movable bearing can be coupled via pre-tensioning, in particular via spring pre-tensioning.

In FIG. 14, an exemplary transmission of force to the individual driving force pick-ups, namely the conveying wheels 46, 48, the embossing and/or deformation wheels 9, 11 and the continuous conveyors 19, 21 is adapted, in which the apparatus 1 can make do with a single drive motor, namely the drive motor 34. The driving force generated by the drive motor is transmitted via a gear directly to the drive shaft 42, on which the lower conveying wheel 48 is rotatably mounted. The upper conveying wheel 46 is free-rotating. The drive force is transmitted via a traction drive in the form of a belt to the drive shaft of the lower embossing and/or deforming wheel, while the upper embossing and/or deforming wheel is freely rotatably mounted on a shaft in order to finally be transmitted to a drive shaft associated with the output device 17, on which in turn a further traction drive is mounted in accordance with the force transmission in order to drive the two continuous conveyors 19, 21, each of which is associated with a drive gear, around which the traction drive is guided in accordance with the force transmission. A separate motor 32 can be assigned to the separating station 13. However, it is also possible that a drive shaft associated with the coupling gear is also driven by the traction drive.

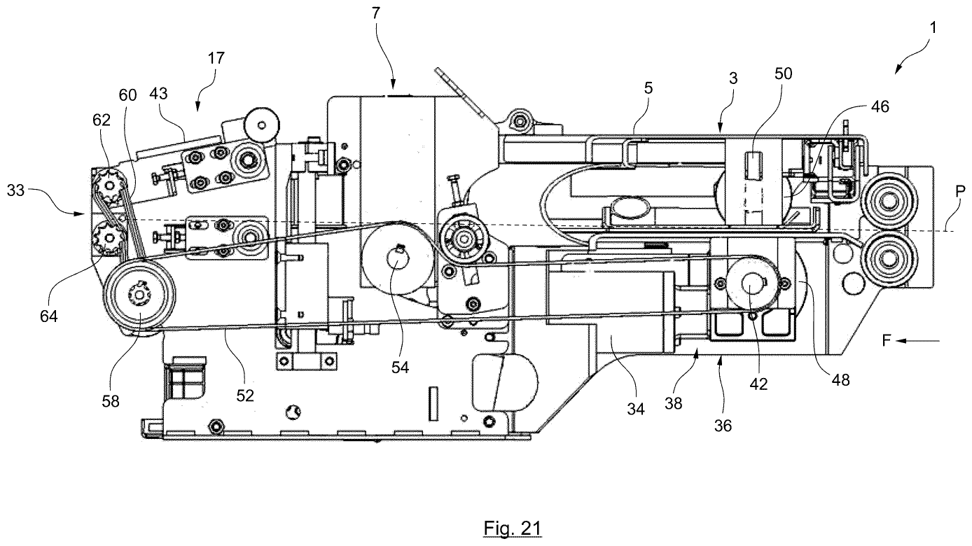

With reference to FIG. 20, the apparatus 1 has a gear 14 associated with the separating station 13 in the form of a coupling gear for converting the torque generated by the drive motor 32 into a translational cutting movement of the cutter 15 of the separating station 13. The up and down movement of the guillotine cutting edge 15 is orientated in such a way that a cutting movement is directed against the direction of gravity, i.e. from bottom to top in the figure.

The drive motor 34 for the embossing and/or perforating station 7 and for the take-off device 36 is directed in the opposite direction to the conveying direction F, so that a drive shaft of the drive motor 34 extends from the motor 34 in the opposite direction to the conveying direction F. The output shaft of the drive motor 34 can transmit the driving force to a drive shaft 42 of the take-off device 36 via a meshing engagement, for example a bevel gear toothing or a worm gear toothing 38. As can be seen in particular in FIG. 20, the take-off device 36 has two take-off or conveying wheels 46, 48, each mounted on a shaft 42, 44, with which the raw material is drawn into the apparatus 1 and conveyed through it. FIG. 20 also shows that the upper conveying wheel 46 is movably mounted in the material thickness direction, i.e. perpendicular to the planar extension of the raw material within the apparatus 1, which is indicated by a rail guide 50 in FIG. 20. Furthermore, the movable bearing can be coupled via pre-tensioning, in particular via spring pre-tensioning.

FIG. 21 shows an exemplary power transmission to the individual driving force pick-ups, namely the conveying wheels 46, 48, the embossing and/or deformation wheels 9, 11 and the continuous conveyors 19, 21. According to the embodiment in FIG. 21, the apparatus 1 manages with a single drive motor, namely the drive motor 34. The drive force generated by the drive motor is transmitted via the gear 38 directly to the drive shaft 42, on which the lower conveying wheel 48 is rotatably mounted. The upper conveying wheel 46 is free-rotating. The drive force is transmitted via a traction drive 52 in the form of a belt to the drive shaft 54 of the lower embossing and/or deforming wheel, while the upper embossing and/or deforming wheel is freely rotatably mounted on a shaft 56, in order to finally be transmitted to a drive shaft 58 associated with the output device 17, on which, in turn, a further traction drive 60 is mounted in accordance with the power transmission in order to drive the two continuous conveyors 19, 21, each of which is assigned a drive gear 62, 64, around which the traction drive 60 is guided in accordance with the power transmission. A separate motor can be assigned to the separating station 13. However, it is also possible that a drive shaft assigned to the coupling gear 14 is also driven by the traction gear 52

Viewed in the opposite conveying direction F, the apparatus 1 in FIG. 20 has a motor 31 for the output device 17, a motor 32 for the separating station 13 and a common motor 34 for the embossing and/or perforating station 7 and the take-off device 36. In the portion of the output device 17, an output device housing 43 can also be seen, which is part of an overall housing 45 of the apparatus. The housing 45 or the output device housing 43 basically serves to prevent undesired access by an operator to the interior of the apparatus 1 in order to avoid injuries, as well as for delimiting the conveying path or the discharge channel 33 and for attaching components of the apparatus 1.

Referring again to FIG. 20, the apparatus 1 has a gear 14 associated with the separating station 13 in the form of a coupling gear for converting the torque generated by the drive motor 32 into a translational cutting movement of the cutter 15 of the separating station 13. The up and down movement of the guillotine cutting edge 15 is orientated in such a way that a cutting movement is directed against the direction of gravity, i.e. from bottom to top in the figure.

The drive motor 34 for the embossing and/or perforating station 7 and for the take-off device 36 is directed in the opposite direction to the conveying direction F, so that a drive shaft of the drive motor 34 extends from the motor 34 in the opposite direction to the conveying direction F. The output shaft of the drive motor 34 can transmit the driving force to a drive shaft 42 of the take-off device 36 via a meshing engagement, for example a bevel gear toothing or a worm gear toothing 38. As can be seen in particular in FIG. 20, the take-off device 36 has two take-off or conveying wheels 46, 48, each mounted on a shaft 42, 44, with which the raw material is drawn into the apparatus 1 and conveyed through it. FIG. 5 also shows that the upper conveying wheel 46 is movably mounted in the material thickness direction, i.e. perpendicular to the planar extension of the raw material within the apparatus 1, which is indicated by a rail guide 50 in FIG. 20. Furthermore, the movable bearing can be coupled via pre-tensioning, in particular via spring pre-tensioning.

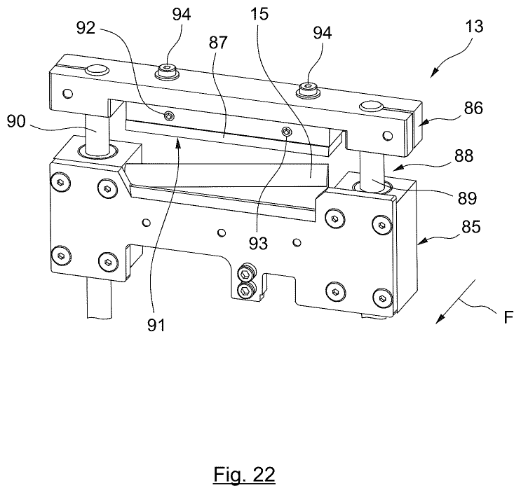

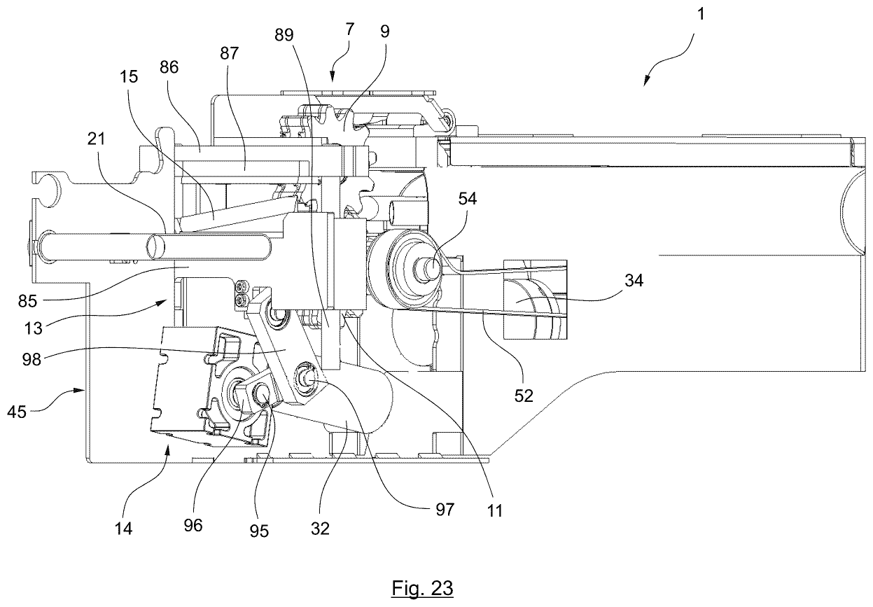

In the embodiment of the separating station 13 according to FIG. 22, the cutter 15 is held and firmly received by a cutter carrier 85. The separating station 13 further may comprise a counter cutter 87 held by a cutter holder 86, which cooperates with the cutter 15 during a separation process in such a way that the cutter 15 shears translationally along or past the counter cutter 87 in order to cut through the raw material web.

During a separation process, the cutter 15 performs a translational cutting movement, which is supported by a guide 88, which is formed as a straight guide according to FIG. 22 and has two guide rods 89, 90 arranged transversely to the conveying direction F at a distance from one another, along which the cutter carrier 85 is guided in translation and in particular in the vertical direction and/or counter to the direction of gravity during a separation process.

In the embodiment shown in FIG. 22, the separating station 13 is equipped with an adjusting device 91 by means of which the cutter 15 and the counter cutter 87 can be positioned relative to one another. In the embodiment shown in FIG. 22, the adjusting device 91 is assigned to the counter cutter 87 and is adapted to displace the counter cutter 87 in the direction of the conveying direction F or in the opposite direction in order to be able to adjust the shear cutting engagement between cutter 15 and counter cutter 87, and thus, for example, a pretensioning force orientated in the direction of the conveying direction F can be set or built up between cutter 15 and counter cutter 87, so that the quality of the separation process can be increased. The adjusting device 91 has, for example, two adjusting screws 92, 93 arranged at a distance from one another transversely to the conveying direction F, which are formed here, for example, as grub screws. Furthermore, it can be seen in FIG. 22 that the counter cutters 87 are detachably attached to the counter cutter carrier 86 by means of two fastening screws 94.

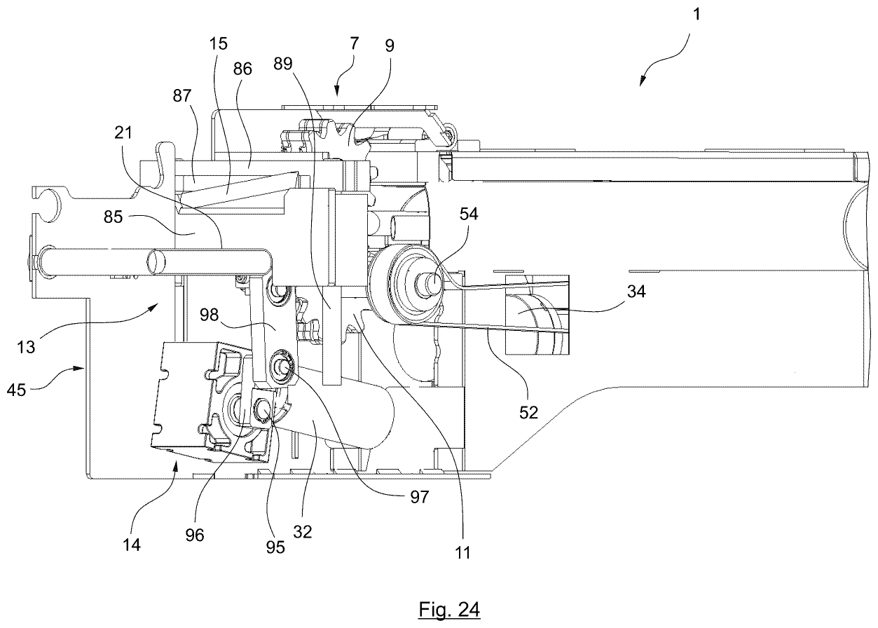

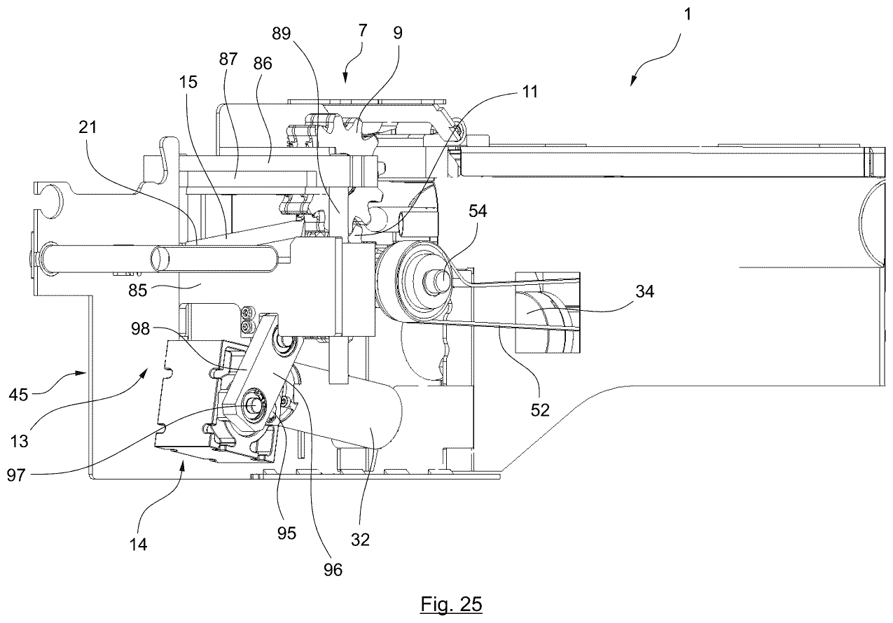

FIGS. 23-25 show three different operating states of the apparatus 1 according to the disclosure, focusing on the separating station 13. In the exemplary embodiment shown in FIGS. 23-25, the separating station 13 is formed as a guillotine cutting station, in which the cutter is guided in translation against the direction of gravity. In FIG. 23, the cutter 15 of the separating station 13 is located shortly before the cutting engagement with the raw material web and at the point in time at which the cutter 15 shears along the counter cutter 87. FIG. 24 shows the uppermost position of the cutter 15 and thus the reversal point from which the cutter 15 must be guided vertically downwards again in order to bring it into an initial position before a new separation process can be started. FIG. 25 shows an intermediate position between the top position (FIG. 24) and a bottom position not shown.

From a synopsis of FIGS. 23-25 it can be seen that the translational cutting movement of the cutter 15 including its cutter carrier 85 is initiated by a motor 32, the driving force of which is transmitted to the cutter 15 and the cutter carrier 85 via a gear 14.

In the exemplary embodiments, the gear 14 is formed as a coupling gear, in which a crank rod 96 mounted in a rotationally fixed manner with a drive shaft 95 is coupled via a ball and socket joint 97 with a further crank rod 98, which ultimately transmits the torque generated by the motor 32 in an axially directed drive actuating force to the cutter 15 or the cutter carrier 85.

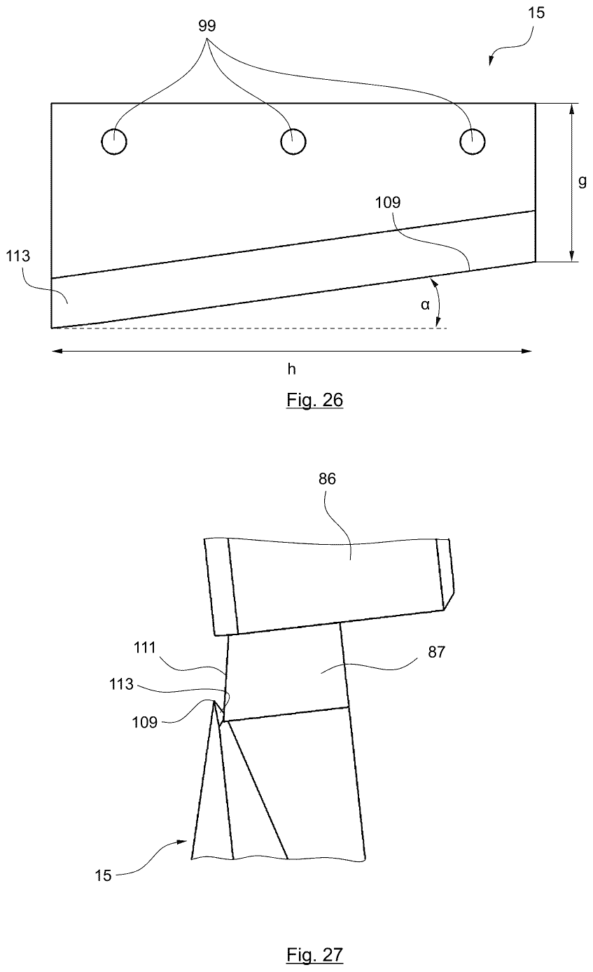

FIGS. 26 and 27 show an example of the design of cutter 15 and counter cutter 87. In the embodiment in FIG. 26, the cutter 15 has fastening holes 99, which are arranged at a distance from one another in a width direction of the cutter 15, which is orientated in the width direction of the raw material web and perpendicular to the translational cutting movement direction, and by means of which the cutter 15 can be fastened to the cutter carrier 85. An essential feature of the cutter 15 is its cutting edge 109, which is arranged at an angle a in relation to the width extension direction of the cutter 15 and whose cutting angle a is in the portion of 3° to 15°. In this respect, an angle in the portion of 93° to 105°results in relation to the translational cutting direction, which is orientated downwards in FIG. 26. For a given width of the raw materials to be cut, the cutting angle a determines the height of the cutting edge g and the width of the cutting edge h. The larger the cutting angle a is selected, the shorter the height of the cutting edge g and the longer the length of the cutting edge 109. Due to the fact that the cutting edge 109 is inclined, a cut through the raw material web spreads transversely to the conveying direction F in the width direction of the raw material web during a separation process. In other words, the varying cutting engagement point between the cutting edge 109 and the raw material web moves transversely to the conveying direction along the cutting edge 109.

FIG. 27 shows a schematic representation of a shear cut engagement between cutter 15 and counter cutter 87. It is clear from this that the counter cutter 87 has a shearing surface 111 which co-operates with the cutter 15 in cutting engagement and which is oriented at an angle of approximately 5° with respect to the direction of translational cutting movement. Furthermore, a cutting surface 113 adjoining the cutting edge 109 is chamfered relative to the rest of the cutting blade.

In the embodiment shown in FIGS. 23 to 25, the output shaft of the gear 14 forms the drive shaft 95 of the coupling gear with the crank rod 96. The center longitudinal axis of the output shaft of the gear 14 or the center longitudinal axis of the drive shaft 95 runs below the conveying path P and transversely to the conveying direction F. The gear 14 is a compactly designed worm gear to which the motor 32 is directly attached. The central longitudinal axis of the motor 32 extends in a substantially longitudinal direction corresponding to the conveying direction F, wherein the central longitudinal axis of the motor 32 and the conveying direction F lie in one plane or wherein the central longitudinal axis of the motor 32 lies in a first vertical plane, the conveying direction F lies in a second vertical plane and the first and second planes are arranged parallel to one another. Furthermore, the center longitudinal axis of the motor 32 is slightly inclined with respect to the horizontal. The space below the other components of the apparatus 1 and in particular below the embossing and/or deformation wheels 9, 11 is optimally utilized, wherein the gear 14 and the motor 32 are positioned close to the other components, so that the apparatus 1 has an extremely compact design.

Since the center longitudinal axis of the drive shaft 95 runs transversely to the conveying direction F, the free end of the crank rod 96, which is fixed on the rotating drive shaft 95, sweeps over a circular surface, which is essentially vertically aligned and is also parallel to the conveying direction F. The free end of the crank rod 96 rotating with the drive shaft 95 is connected in an articulated and rotatable manner to a further crank rod 98, which is formed in the manner of a connecting rod. Both end regions of the connecting rod-like crank rod 98 have a joint, wherein the first joint is rotatably connected to the crank rod 96 as described at the beginning and the second joint is pivotably connected to the cutter carrier 85. All center longitudinal axes of the drive shaft 95 and the joints of the crank rods 96, 98 run parallel to the counter cutter 87. It is thus possible to arrange the entire crank drive for the movability of the cutter 15 consisting of the crank rods 96, 98 and its joints in relation to the conveying direction F next to the gear 14, while the cutter carrier 85 is arranged directly above the gear 14. In order to achieve an even more compact design, in an inventive manner the cutter carrier 85 provides a recess which faces the gear 14 and causes the cutter 15 to approach the gear 14 very closely in the lower end position. Overall, it is thus achieved that the movement stroke of the cutter 15, as well as the crank eccentricity of the crank rod 96, as well as the distance between the pivot points of the crank rod 98 are adapted to each other in such a way that a particularly compact design is formed.

A special feature of the output device 17 should also be mentioned, which is arranged downstream and in the conveying direction F directly after the cutter 15. The counter cutter 87 with the counter cutter carrier 86 is arranged upstream of the cutter 15 and against the conveying direction F. During the separation of a packaging product 100, the cutter 15 pushes the material strand against the counter cutter 87 or against the counter cutter carrier 86, whereby the material strand is supported upstream. Downstream, the output device 17 is arranged directly next to the cutter 15. The continuous conveyor 19 of the output device 17 is formed at least sectionally as a further support, so that the material strand is supported both upstream by the counter cutter 87 and downstream by the continuous conveyor 19 during the cutting process of the cutter 15, even if the continuous conveyor 19 is at a small distance from the cutter 15. The supporting effect of the continuous conveyor 19 has proven to be particularly advantageous because the material strand remains essentially straight and aligned along the conveying direction F during cutting. A clean and particularly smooth cut of the cutter 15 is thus achieved. In a particularly advantageous embodiment of the continuous conveyor 19, this is formed as a conveyor belt tensioned between two reversing rollers. In order to achieve a particularly good supporting effect, at least the reversing roller of the continuous conveyor 19 facing the cutter 15 has a relatively small diameter of no more than 30 millimeters.

The features disclosed in the above description, the figures, and the claims can be of importance both individually and in any combination for the realization of the disclosure in the various embodiments.

### LIST OF REFERENCE SYMBOLS

1 Apparatus
2 Raw material web
3 Preforming station
4 Raw material supply
5 Turn-in or rolling-in device
6 Stator
7 Embossing and/or perforating station
9,11 Embossing and/or perforating wheels
13 Separating station
14 Gear
15 Cutter
17 Output device
19, 21 Continuous conveyor
23, 25, 27, 29 Reversing roller
31, 32, 34 Motor
33 Discharge channel
36 Take-off device
38 Worm gear toothing
35, 37, 39, 41 Conveyor section
42, 44 Shaft
43 Delivery device housing
45 Housing
46, 48 Take-off or conveying wheels
47 Fastening and/or deformation zone conveyor section
49 Cylindrical section
50 Rail guide
51, 53 frustoconical section
52 Traction drive
54 Drive shaft
56 Shaft
57 straight conveyor section
58 Drive shaft
59 Delivery opening
60 Traction drive
61, 63 Crumple cavity passage
62, 64 Drive gear
65 Fastening and/or deformation zone passage
67, 69 Housing part
71,73 Crumple cavity channel
75,77 Housing half
79, 81 Housing beam
83 Housing part
85 Cutter carrier
86 Counter cutter carrier
87 Counter cutter
88 Guide
89, 90 Guide rod
91 Adjusting device
92,93 Adjusting screw
94 Fastening screw
95 Drive shaft
96, 98 Crank rod
97 Ball and socket joint
99 Fastening hole
100 Packaging product
103, 105 Crumple cavity
107 Fastening and/or deformation zone
109 Cutting edge
111 Shearing surface
113 Cutting surface
115 System
117 Frame
119 Raw material supply holder
F Conveying direction
S pivot axis
P Conveying path
R Swiveling direction
a Width of the packaging product
b Height of the packaging product
c Length of the packaging product
d Width of the fastening and/or deformation zone
e Height of the fastening and/or deformation zone
g Height of the cutting edge
h Width of the cutting edge

1. An apparatus adapted to produce a three-dimensional packaging product from a web-shaped raw material, the apparatus comprising:
a preforming station configured to deform the raw material web into a three-dimensional intermediate product having at least one crumple cavity extending in a web direction;
a separating station adjoining the preforming station in a conveying direction of the raw material and configured to separate a packaging product of a desired length from the raw material web; and
an output device adjoining the separating station in the conveying direction of the raw material and having a pair of mutually opposite continuous conveyors configured to discharge the separated packaging product, wherein a first continuous conveyor of the continuous conveyors is mounted movably relative to a second continuous conveyor of the continuous conveyor and configured to allow access between the continuous conveyors.

2. The apparatus according to claim 1, wherein the first continuous conveyor is pivotable relative to the second continuous conveyor.

3. The apparatus according to claim 2, wherein a swivelling direction is orientated in a direction of the conveying direction of the raw material.

4. The apparatus according to claim 2, wherein the pivotable first continuous conveyor is floatingly mounted.

5. The apparatus according to claim 1, wherein the first continuous conveyor projects beyond the second continuous conveyor counter to the conveying direction of the raw material.

6. The apparatus according to claim 1, wherein: the first continuous conveyor extends against the conveying direction at least as far as the separating station; and/or the first continuous conveyor is guided around a reversing roller on a separating station side, an axis of rotation of which lies upstream of the separating station in the conveying direction.

7. The apparatus according to claim 1, wherein the preforming station is configured to deform the raw material into the three-dimensional intermediate product to form two lateral crumple cavities extending in the web direction and a central fastening and/or deformation zone extending in the web direction, at least one of the first and second continuous conveyors is configured to engage between resulting crumple cavities of the separated packaging product and make conveying contact with a resulting central fastening and/or deformation zone of the separated packaging product.

8-13. (canceled)

14. The apparatus according to claim 1, wherein the continuous conveyors are dimensioned to project by at least 0.5 cm at both lateral ends of a separated packaging product.

15. The apparatus according to claim 1, wherein at least one of the first and second continuous conveyors includes at least two conveyor sections distributed transversely to the conveying direction.

16. The apparatus according to claim 1, further comprising a sensor associated with at least one of the first and the second continuous conveyors and configured to register a deformation and/or a change in position of the at least one of the first and the second continuous conveyors to detect or anticipate a material jam.

17. The apparatus according to claim 16, wherein:
the at least one of the first and the second continuous conveyors is formed as a conveyor belt and the sensor is associated with the conveyor belt and configured to detect a deflection of the conveyor belt, or
the conveyor belt is movably mounted relative to the preforming station, the sensor being configured to detect a movement of the conveyor belt relative to the preforming station.

18. The apparatus according to claim 1, wherein:
the first and the second continuous conveyors are configured to delimit a conveying path between them, each of the first and the second continuous conveyors being guided around respective first and second reversing rollers;
a downstream one of the first and second reversing rollers of each of the first and second continuous conveyors is arranged at a same height with respect to the conveying direction of the raw material; and
the first and the second continuous conveyors are arranged relative to one another such that a cross-section of the conveying path, starting from an end of the conveying path on a separation station side, decreases in the conveying direction of the raw material to a minimum in a portion of the downstream reversing rollers of the first and the second continuous conveyors.

19-22. (canceled)

23. A system comprising:
an apparatus according to claim 1; and
a raw material supply arranged with respect to the apparatus.

24-56. (canceled)

57. The apparatus according to claim 1, wherein the first continuous conveyor is an upper continuous conveyor and the second continuous conveyor is a lower continuous conveyor.

58. The apparatus according to claim 2, wherein the first continuous conveyor is configured to be pivotable: beyond a 90° position with respect to the second continuous conveyor, or into a parallel position with respect to the second continuous conveyor.

59. The apparatus according to claim 2, wherein the pivotable first continuous conveyor is configured to be guided around at least two reversing rollers and pivotable around a downstream reversing roller of the at least two reversing rollers in the conveying direction.

60. The apparatus according to claim 1, further comprising a sensor configured to detect a deformation and/or a change in position of at least one of the first and the second continuous conveyors to detect or anticipate a material jam.

61. The apparatus according to claim 1, further comprising a sensor configured to detect a deflection of at least one of the first and the second continuous conveyors to detect or anticipate a material jam.

62. The apparatus according to claim 1, wherein at least one of the first and the second continuous conveyors is movably mounted relative to the preforming station, the apparatus further including a sensor configured to detect a movement of the at least one of the first and the second continuous conveyors to detect or anticipate a material jam.

63. The apparatus according to claim 7, wherein the at least one of the first and second continuous conveyors comprises two angled sections and a central section arranged between the two angled sections in a direction transverse to the conveying direction, the central section being configured to engage the central fastening and/or deformation zone, and the two angled sections being configured to engage the two lateral crumple cavities, respectively.
